(19) United States
(12) Patent Application Publication
(10) Pub. No.: US 2025/0377448 A1
(43) Pub. Date: Dec. 11, 2025

(54) RADAR APPARATUS AND RADAR SIGNAL PROCESSING METHOD

(71) Applicant: Panasonic Automotive Systems Co., Ltd., Kanagawa (JP)

(72) Inventor: Takaaki KISHIGAMI, Tokyo (JP)

(21) Appl. No.: 19/199,867

(22) Filed: May 6, 2025

(30) Foreign Application Priority Data
Jun. 5, 2024 (JP) 2024-091507

(51) Int. Cl. G01S 13/42; G01S 7/03

(52) U.S. Cl. CPC G01S 13/42; G01S 7/03

(57) ABSTRACT

In a radar apparatus, an r1th antenna and an r2th antenna of the first antenna group are arranged adjacent to each other in a third direction different from both a first direction and a second direction orthogonal to the first direction, a t1th antenna and a t2th antenna of the second antenna group are arranged adjacent to each other in the third direction, an r3th antenna of the first antenna group is arranged at a position shifted beyond a defined value in each of the first direction and the second direction from the third direction, the defined value being based on a wavelength of the transmission signal, and an absolute value of a difference between a spacing between the r1th antenna and the r2th antenna and a spacing between the t1th antenna and the t2th antenna is the defined value, or, the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

### TECHNICAL FIELD

The present disclosure relates to a radar apparatus and a radar signal processing method.

### BACKGROUND ART

Recently, a study of radar apparatuses using a radar transmission signal of a short wavelength including a microwave or a millimeter wave that allows high resolution has been carried out. Further, it has been demanded to develop a radar apparatus which senses small objects such as pedestrians in addition to vehicles in a wide-angle range (e.g., referred to as “wide-angle radar apparatus”) in order to improve the outdoor safety.

Examples of the configuration of the radar apparatus having a wide-angle sensing range include a configuration using a technique of receiving a reflected wave from a target object by an array antenna composed of a plurality of antennas (also referred to as antenna elements), and estimating the direction of arrival of the reflected wave (also referred to as the angle of arrival) using a signal processing algorithm based on received phase differences with respect to element spacings (antenna spacings) (Direction of Arrival (DOA) estimation).

Examples of the DOA estimation include a Fourier method (Fast Fourier Transform (FFT) method), and, a Capon method, Multiple Signal Classification (MUSIC), and Estimation of Signal Parameters via Rotational Invariance Techniques (ESPRIT) that are methods achieving higher resolution.

In addition, a radar apparatus has been proposed which, for example, includes a plurality of antennas (array antenna) at a transmitter in addition to at a receiver, and is configured to perform beam scanning through signal processing using the transmission and reception array antennas (also referred to as Multiple Input Multiple Output (MIMO) radar) (e.g., see Non-Patent Literature (hereinafter referred to as “NPL”) 1).

### CITATION LIST

### Non Patent Literature

### NPL 1

J. Li, and P. Stoica, “MIMO Radar with Colocated Antennas”, Signal Processing Magazine, IEEE Vol. 24, Issue: 5, pp. 106-114, 2007
NPL 2
Kazuo Shirakawa et al., “3D-Scan Millimeter-Wave Radar for Automotive Application,” Fujitsu Ten technical report, Vol. 30, No. 1, 2012.
NPL 3
M. Kronauge, H. Rohling, “Fast two-dimensional CFAR procedure”, IEEE Trans. Aerosp. Electron. Syst., 2013, 49, (3), pp. 1817-1823
NPL 4
Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, there is scope for further study on a method for improving the angular measurement accuracy or resolution in a radar apparatus (e.g., a MIMO radar).

One non-limiting and exemplary embodiment of the present disclosure facilitates providing a radar apparatus and a radar signal processing method with improved angular accuracy or resolution.

A radar apparatus according to one exemplary embodiment of the present disclosure includes: A radar apparatus, comprising: transmission circuitry, which, in operation, transmits a transmission signal using either one of a first antenna group and a second antenna group; and reception circuitry, which, in operation, receives a reflected wave signal using an other of the first antenna group and the second antenna group, the reflected wave signal being the transmission signal reflected by an object, in which an r1th antenna and an r2th antenna of the first antenna group are arranged adjacent to each other in a third direction different from both a first direction and a second direction orthogonal to the first direction, a t1th antenna and a t2th antenna of the second antenna group are arranged adjacent to each other in the third direction, an r3th antenna of the first antenna group is arranged at a position shifted beyond a defined value in each of the first direction and the second direction from the third direction, the defined value being based on a wavelength of the transmission signal, and an absolute value of a difference between a spacing between the r1th antenna and the r2th antenna and a spacing between the t1th antenna and the t2th antenna is the defined value, or, the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

It should be noted that general or specific embodiments may be implemented as a system, a method, an integrated circuit, a computer program, a storage medium, or any selective combination thereof.

According to an exemplary embodiment of the present disclosure, the angular measurement accuracy or resolution of a radar apparatus can be enhanced

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an arrangement example of MIMO antennas and virtual reception antennas;

FIG. 2 illustrates an example of a direction estimation result;

FIG. 3 illustrates an example of a direction estimation result;

FIG. 4 illustrates an example of a direction estimation result;

FIG. 5 is a block diagram illustrating an exemplary configuration of a radar apparatus;

FIG. 6 illustrates an example of a transmission signal and a reflected wave signal when a chirp pulse is used;

FIG. 7 illustrates an arrangement example of MIMO antennas and virtual reception antennas;

FIG. 8 illustrates an example of a direction estimation result;

FIG. 9 illustrates arrangement examples of MIMO antennas;

FIG. 10 illustrates exemplary configurations of a subarray;

FIG. 11 illustrates an arrangement example of MIMO antennas and virtual reception antennas;

FIG. 12 illustrates an example of a direction estimation result;

FIG. 13 illustrates an arrangement example of MIMO antennas and virtual reception antennas;

FIG. 14 illustrates an arrangement example of MIMO antennas and virtual reception antennas;

FIG. 15 illustrates an example of a direction estimation result;

FIG. 16 illustrates an arrangement example of MIMO antennas and virtual reception antennas;

FIG. 17 illustrates an arrangement example of MIMO antennas and virtual reception antennas;

FIG. 18 illustrates an example of a direction estimation result;

FIG. 19 illustrates an arrangement example of MIMO antennas and virtual reception antennas; and

FIG. 20 illustrates an arrangement example of MIMO antennas and virtual reception antennas.

### DESCRIPTION OF EMBODIMENTS

A MIMO radar transmits, from a plurality of transmission antennas (also referred to as “transmission array antenna”), signals (radar transmission waves) that are multiplexed using time-division, frequency-division, Doppler, or code-division multiplexing, for example. The MIMO radar then receives signals (radar reflected waves) reflected, for example, by an object around the radar using a plurality of reception antennas (also referred to as “reception array antenna”) to separate and receive multiplexed transmission signals from reception signals. With this processing, the MIMO radar can extract a propagation path response indicated by the product of the number of transmission antennas and the number of reception antennas, and performs array signal processing using these reception signals as a virtual reception array.

In the MIMO radar, the virtual reception array antenna (hereinafter, referred to as the virtual reception array, a MIMO virtual reception array, a virtual reception antenna, or a virtual reception array antenna) equal in number to the product of the number of transmission antenna elements and the number of reception antenna elements at most can be configured by devising arrangement of the antenna elements in a transmission/reception array antenna. It is thus possible to obtain the effect of increasing the effective aperture length of the array antenna by a small number of elements, so as to enhance the angular measurement accuracy or the resolution.

In addition, the MIMO radar is applicable not only to one-dimensional scanning (angular measurement) in a vertical direction or a horizontal direction but also to two-dimensional beam scanning (angular measurement) in the vertical direction and the horizontal direction (for example, see NPL 2).

Two-dimensional angle measurement can be used, for example, for determining obstacles including height information in Advanced Driver Assistance Systems (ADAS) applications, and can improve radar detection performance. On the other hand, two-dimensional angle measurement uses antennas arranged two-dimensionally in the vertical and horizontal directions, requiring more antennas compared to one-dimensional angle measurement.

For example, by improving the accuracy of two-dimensional angle measurement in a MIMO radar including a small number of antennas, it is expected to reduce the cost of high-performance radar detection systems. Additionally, for example, by using a plurality of MIMO radars including a small number of antennas, it is expected to expand the coverage area and reduce the cost of ADAS systems that monitor the entire surroundings, such as vehicles.

In one non-limiting exemplary embodiment of the present disclosure, a method (e.g., antenna arrangement) for improving the two-dimensional angle measurement accuracy of a MIMO radar formed using a small number of antennas (limited number of antennas, e.g., 2 transmission antennas and 3 reception antennas) is described.

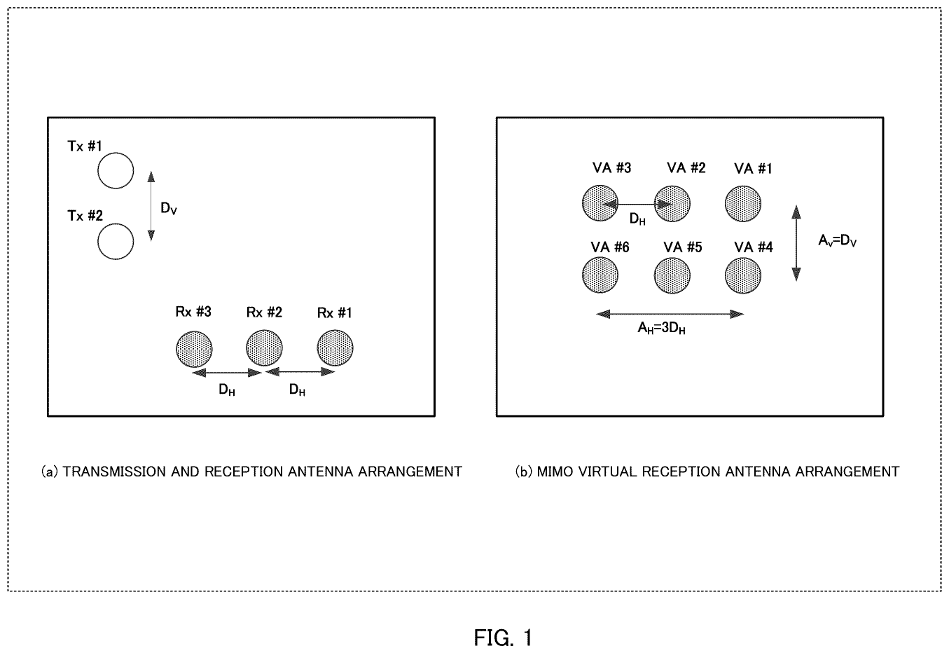

FIG. 1 illustrates an example of transmission and reception antenna arrangement of a MIMO radar (hereinafter also referred to as MIMO antenna arrangement) and virtual reception antenna arrangement. Part (a) of FIG. 1 shows two transmission antennas (Tx #1 and Tx #2) arranged in the vertical direction (in the longitudinal direction in part (a) of FIG. 1), and three reception antennas (Rx #1 to Rx #3) arranged in the horizontal direction (in the lateral direction in part (a) of FIG. 1). In part (a) of FIG. 1, the transmission antennas are arranged at equal spacings (D_{V}) in the vertical direction, and the reception antennas are arranged at equal spacings (D_{H}) in the horizontal direction.

Part (b) of FIG. 1 shows a virtual reception antenna configured based on the antenna arrangement shown in part (a) of FIG. 1. The virtual reception antenna arrangement configured based on the MIMO antenna arrangement is disclosed, for example, in NPL 1. For example, the virtual reception antenna shown in part (b) of FIG. 1 is composed of 6 elements of virtual antennas (VA #1 to VA #6) with 3 antennas arranged in the horizontal direction and 2 antennas arranged in the vertical direction in a rectangular shape. In part (b) of FIG. 1, the horizontal and vertical element spacings of the virtual reception antenna are D_{H} and D_{V}, respectively. The horizontal and vertical aperture lengths A_{H} and A_{V} of the virtual reception array are A_{H}=3D_{H} and A_{V}=D_{V}, respectively.

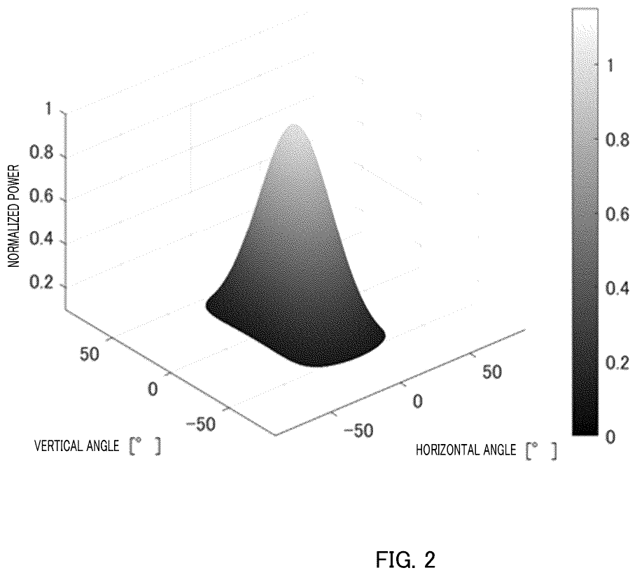

FIG. 2 shows an angle measurement result obtained using the two-dimensional Fourier method for a target object at 0° in the horizontal and vertical directions, using a received signal by the virtual reception antenna shown in part (b) of FIG. 1, when the horizontal element spacing D_{H}=0.5λ and the vertical element spacing D_{V}=0.5λ in the antenna arrangement of the MIMO radar shown in part (a) of FIG. 1. Note that each antenna is assumed to be omnidirectional, FIG. 2 shows a spatial profile representing the normalized reception power in the horizontal and vertical directions, and the direction of a reception power peak represents the target object direction by two-dimensional angle measurement. Note that λ represents the wavelength of the radar carrier wave.

As shown in FIG. 2, a main beam (main lobe) is formed at 0° in the horizontal and vertical directions, and the target object direction is detected. Here, the narrower the beam width of the main beam, the higher the angle measurement accuracy and the better the angular separation performance for a plurality of target objects. For example, in FIG. 2, the 3 dB beam width (half-power width) in the horizontal direction is about 37°, and the 3 dB beam width in the vertical direction is about 59°.

In two-dimensional angle measurement in the MIMO radar formed using a smaller number of antennas (e.g., a limited number of antennas), the horizontal and vertical aperture lengths are not sufficiently secured, and the two-dimensional angle measurement accuracy tends to be insufficient. For example, in the antenna arrangement example of FIG. 1, the vertical aperture is narrower than the horizontal aperture, so the 3 dB beam width in the vertical direction tends to be wider, and the angle measurement accuracy in the vertical direction tends to be lower than that in the horizontal direction. Additionally, for example, in FIG. 1, when the vertical antenna spacing is increased, the 3 dB beam width in the vertical direction narrows, improving angle measurement accuracy, but grating lobes may occur.

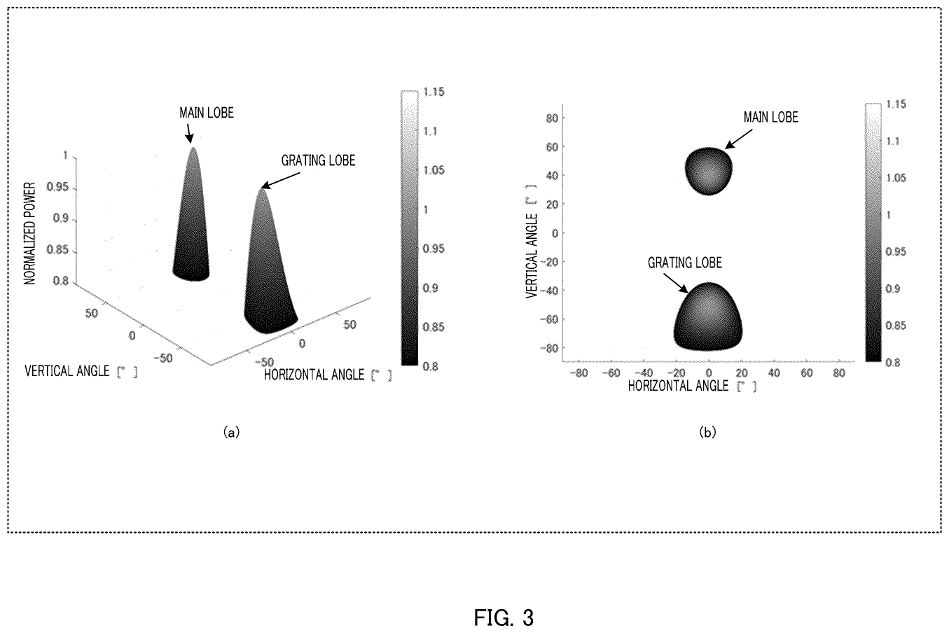

For example, FIG. 3 shows an example of angle measurement results obtained using the two-dimensional Fourier method with the received signal by the virtual reception antenna of part (b) of FIG. 1, when vertical antenna spacing D_{V}=0.7λ and horizontal antenna spacing D_{H}=0.5λ in the antenna arrangement of the MIMO radar shown in part (a) of FIG. 1. The example in FIG. 3 shows the angle measurement results obtained using the two-dimensional Fourier method for a target object at 0° in the horizontal direction and 40° in the vertical direction. As shown in FIG. 3, a main lobe is formed at 0° in the horizontal direction and 40° in the vertical direction, and the target object direction is detected. On the other hand, as shown in FIG. 3, a grating lobe (at 0° in the horizontal direction and −51° in the vertical direction) is generated in addition to the main beam. In FIG. 3, the peak level of the grating lobe is equivalent to that of the main beam, making it difficult for the radar apparatus to distinguish the true target object direction.

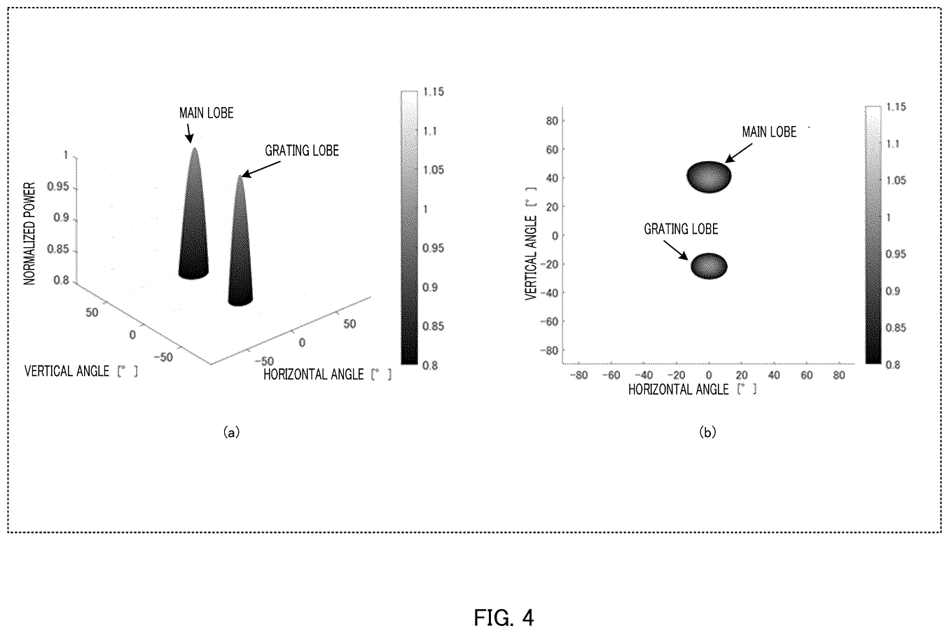

Similarly, for example, FIG. 4 shows an example of angle measurement results obtained using the two-dimensional Fourier method with the received signal at the virtual reception antenna of part (b) in FIG. 1, in the MIMO radar antenna arrangement shown in part (a) in FIG. 1, where vertical antenna spacing D_{V}=λ and horizontal antenna spacing D_{H}=0.5λ. The example in FIG. 4 shows the angle measurement results obtained using the two-dimensional Fourier method for a target object at 0° in the horizontal direction and 40° in the vertical direction, similar to FIG. 3. As shown in FIG. 4, the grating lobe is generated along with the main lobe directed towards the target object direction (at 0° in the horizontal direction and 40° in the vertical direction). In the example of FIG. 4, compared to FIG. 3, the angular spacing at which the main lobe and grating lobes are generated is narrower. From FIGS. 3 and 4, it can be confirmed that the larger vertical antenna spacing D_{V}, the narrower the angular spacing at which the grating lobe is generated.

Here, when vertical antenna spacing D_{V}=0.7λ and horizontal antenna spacing D_{H}=0.5λ, the 3 dB beam width (half-power width) for a target object at 0° in the horizontal and vertical directions is approximately 37° in the horizontal direction and approximately 41° in the vertical direction. Also, when vertical antenna spacing D_{V}=λ and horizontal antenna spacing D_{H}=0.5λ, the 3 dB beam width (half-power width) for a target object at 0° in the horizontal and vertical directions is approximately 37° in the horizontal direction and approximately 29° in the vertical direction.

Thus, when the vertical antenna spacing is increased beyond 0.5λ, the 3 dB beam width narrows, improving the vertical angle measurement accuracy, but a grating lobe is generated. For example, when an assumed sensing angle range is wider than an angle at which a grating lobe is generated, the probability that the radar apparatus erroneously detects, as a target object, a false peak caused by the grating lobe within the sensing angle range increases, and the radar detection performance is likely to deteriorate. Moreover, even when the grating lobe is outside the assumed sensing angle range, when the power of a reflected wave arriving from the grating lobe direction is sufficiently large, the radar apparatus may erroneously detect that the target object has arrived within the field of view, and the radar detection performance is likely to deteriorate.

Further, like the case of the above-described vertical direction, also in a case where the horizontal antenna spacing is widened, the horizontal beam width narrows, and the horizontal angle measurement accuracy or angular resolution is improved, but widening the horizontal spacing beyond 0.5 wavelengths results in the generation of grating lobes, and the radar detection performance is likely to deteriorate.

For example, an antenna arrangement capable of suppressing grating lobes while widening the vertical or horizontal antenna spacing is expected.

One non-limiting and exemplary embodiment of the present disclosure will be described in relation to an antenna arrangement capable of suppressing a grating lobe while increasing an element spacing in at least one of a vertical direction and/or a horizontal direction. By realizing such an antenna arrangement, the angular measurement accuracy or the resolution can be enhanced by using a smaller number of antennas.

The radar apparatus according to one exemplary embodiment of the present disclosure may be configured to be mounted on a mobile entity such as a vehicle, for example. The radar apparatus configured to be mounted on the mobile entity can be used, for example, as an Advanced Driver Assistance System (ADAS) for enhancing the collision safety, or as a sensor used for monitoring the periphery of the mobile entity during autonomous driving.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians.

The use of the radar apparatus is not limited to the above, and the radar apparatus may also be used for other uses.

Hereinafter, embodiments according to exemplary embodiments of the present disclosure will be described in detail with reference to the accompanying drawings. Note that, in the embodiments, the same constituent elements will be denoted with the same reference signs, and descriptions thereof will be omitted to avoid redundancy.

In the following, a description is given of a radar apparatus having a configuration in which a transmission branch transmits different code-division multiplexed transmission signals from a plurality of transmission antennas, and a reception branch performs reception processing by separating each of the transmission signals (for example, a MIMO radar configuration). However, the configuration of the radar apparatus is not limited thereto, and the radar apparatus may have a configuration in which the transmission branch transmits different frequency-division multiplexed transmission signals from a plurality of transmission antennas, and the reception branch performs reception processing by separating each of the transmission signals. Similarly, the configuration of the radar apparatus may be a configuration in which the transmission branch time-division multiplexed transmission signals from a plurality of transmission antennas and the reception branch performs reception processing.

Similarly, the radar apparatus may have a configuration in which the transmission branch transmits Doppler-division multiplexed transmission signals from a plurality of transmission antennas, and the reception branch performs reception processing by separating each of the transmission signals. Similarly, the radar apparatus may have a configuration in which the transmission branch transmits, from a plurality of transmission antennas, transmission signals multiplexed in combination of at least two of code-division multiplexing, frequency-division multiplexing, and Doppler-division multiplexing, and the reception branch performs reception processing by separating each of the transmission signals.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is applicable to a radar system using a single pulse or an encoded pulse.

### [Configuration of Radar Apparatus]

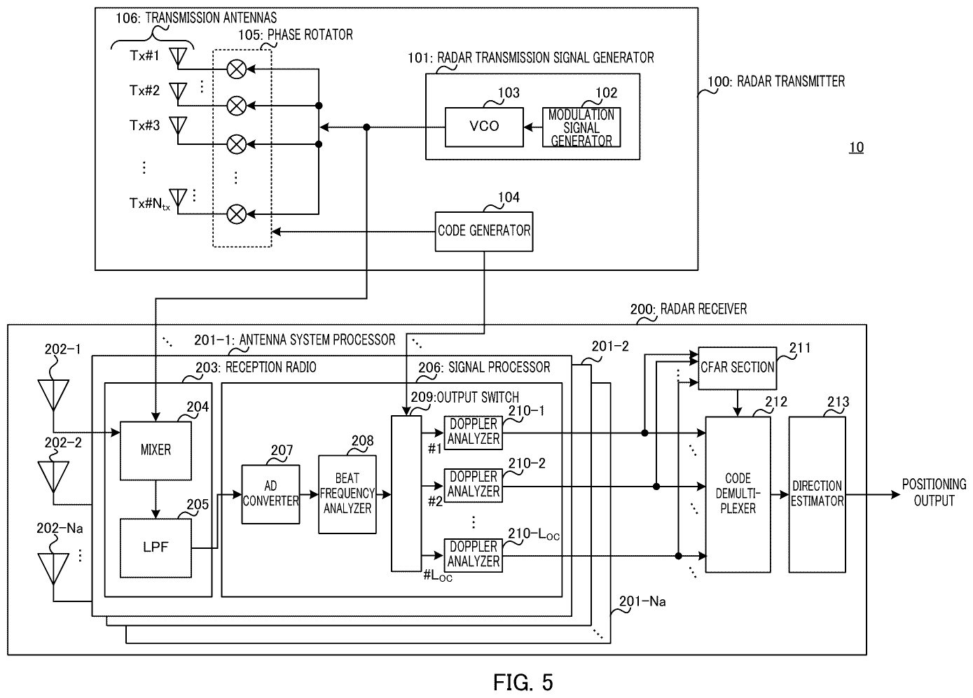

FIG. 5 is a block diagram illustrating an exemplary configuration of radar apparatus 10 according to the present embodiment.

Radar apparatus 10 includes radar transmitter (transmission branch) 100 and radar receiver (reception branch) 200.

Radar transmitter 100 generates a radar signal (radar transmission signal) and transmits the radar transmission signal in a defined transmission period by using a transmission array antenna formed of a plurality of (for example, Nₜₓ) transmission antennas 106.

Radar receiver 200 receives a reflected wave signal, which is the radar transmission signal reflected by a target object (not illustrated), using a reception array antenna including a plurality of reception antennas 202 (e.g., Na). Radar receiver 200 performs signal processing on the reflected wave signals received at reception antennas 202 to, for example, detect the presence or absence of the target object, or estimate the distances through which the reflected wave signals arrive, the Doppler frequencies (for example, the relative velocities), and the directions of arrival, and outputs information on an estimation result (for example, positioning information).

Note that, the target object is an object to be detected by radar apparatus 10, and includes a vehicle (including a four-wheel vehicle and a two-wheeled vehicle), a person, a block, or curb, for example.

### [Configuration of Radar Transmitter 100]

Radar transmitter 100 includes radar transmission signal generator 101, code generator 104, phase rotators 105, and transmission antennas 106.

Radar transmission signal generator 101 generates a radar transmission signal. Radar transmission signal generator 101 includes, for example, modulation signal generator 102 and Voltage Controlled Oscillator (VCO) 103. Hereinafter, the components of radar transmission signal generator 101 will be described.

Modulation signal generator 102 periodically generates, for example, saw-toothed modulation signals (e.g., modulation signals for VCO control) for each radar transmission period Tr.

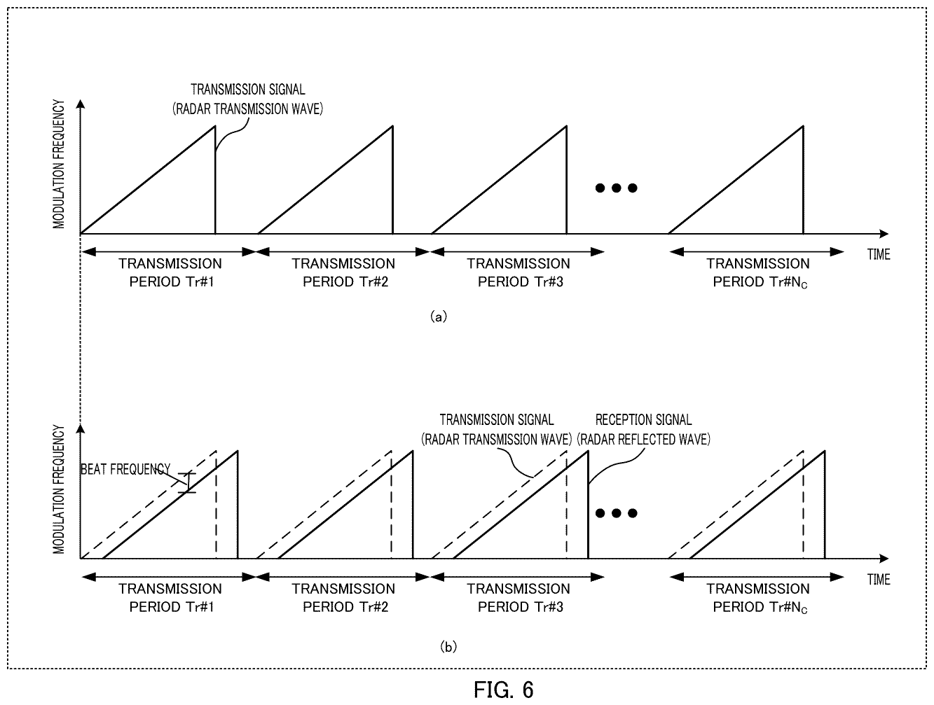

VCO 103 generates frequency-modulated signals (hereinafter referred to as, for example, frequency chirp signals or chirp signals) based on the modulation signals inputted from modulation signal generator 102, and outputs the frequency-modulated signals to phase rotators 105 and radar receiver 200 (mixer 204 described below) as the radar transmission signals (radar transmission waves), as illustrated at (a) of FIG. 6.

Code generator 104 generates respective different codes for transmission antennas 106 that perform code multiplexing transmission. Code generator 104 outputs phase rotation amounts corresponding to the generated codes to phase rotators 105. Further, code generator 104 outputs information on the generated code to radar receiver 200 (output switch 209 to be described later).

Phase rotators 105 apply the phase rotation amounts inputted from code generator 104 to the chirp signals inputted from VCO 103 and outputs the signals subjected to phase rotation to transmission antennas 106. For example, each of phase rotators 105 includes a phase shifter, a phase modulator, and the like (not illustrated). The output signals of phase rotators 105 are amplified to a defined transmission power and are radiated respectively from transmission antennas 106 to space. For example, radar transmission signals are transmitted in a code-multiplexing manner by application of the phase rotation amounts corresponding to the codes and are transmitted from a plurality of transmission antennas 106.

Next, one example of the codes (e.g., orthogonal codes) configured in radar apparatus 10 will be described.

Code generator 104 generates, for example, respective different codes for transmission antennas 106 that perform code multiplexing transmission.

By way of example, in the following, the number of transmission antennas 106 that perform code multiplexing transmission is denoted by “Nt” and the number of code multiplexing is denoted by “N_{CM}.” In FIG. 5, N_{CM}=Nt.

For example, code generator 104 configures, as codes for code multiplexing transmission, N_{CM} orthogonal codes among N_{allcode} (or N_{allcode}(Loc)) orthogonal codes included in code sequences with code length (e.g., the number of code elements, in other words) Loc (for example, the orthogonal code sequences that are orthogonal to each other (also simply referred to as codes or orthogonal codes)).

For example, number N_{CM} of code multiplexing is equal to or less than number N_{allcode} of orthogonal codes; N_{CM}≤N_{allcode} holds true. For example, N_{CM} orthogonal codes with code length Loc are represented as Code_{ncm}=[OC_{ncm}(1), OC_{ncm}(2), . . . , OC_{ncm}(Loc)]. Here, “OC_{ncm}(noc)” represents the nocth code element in ncmth orthogonal code Code_{ncm}. Further, “ncm” represents the index of an orthogonal code used for code multiplexing, and ncm=1, . . . , N_{CM}. Further, “noc” denotes the index of a code element, and noc=1, . . . , Loc.

As described above, N_{CM} orthogonal codes generated in code generator 104 are, for example, codes orthogonal to each other (in other words, uncorrelated codes). For example, a Walsh-Hadamard code may be used for an orthogonal code sequence.

In the following, by way of example, code lengths Loc of the orthogonal code sequences with N_{CM} codes may be configured to satisfy following Expression 1:

$$[ 1 ]$$

$$L o c \geq {2}^{ceil [ {log}_{2} {N}_{C M} ]} . \qquad ( Expression 1 )$$

Here, ceil[x] is an operator (ceiling function) that outputs the smallest integer greater than or equal to real number x. Code generator 104 uses, for example, N_{CM} orthogonal codes among N_{allcode}(Loc) codes included in a Walsh-Hadamard code with code length Loc.

Note that, code elements constituting an orthogonal code sequence are not limited to real numbers and may include complex number values.

Note also that the codes may also be other orthogonal codes different from the Walsh-Hadamard codes. For example, the codes may be orthogonal M-sequence codes or pseudo-orthogonal codes.

An example of the orthogonal codes in each case of number N_{CM} of code multiplexing has been described above.

Next, an exemplary phase rotation amount based on the codes for code multiplexing transmission generated in code generator 104 will be described.

For example, radar apparatus 10 performs code multiplexing transmission using different orthogonal codes for respective transmission antennas Tx #1 to Tx #NT that perform the code multiplexing transmission. For example, code generator 104 sets phase rotation amount ψ_{ncm}(m) based on orthogonal code Code_{ncm} that is to be applied to ncmth transmission antenna Tx #ncm at mth transmission period Tr, and outputs phase rotation amount ψ_{ncm}(m) to phase rotator 105. Here, ncm=1, . . . , N_{CM}.

For example, phase rotation amount ψ_{ncm}(m) cyclically applies phase amounts corresponding to Loc code elements OC_{ncm}(1), . . . , OC_{ncm}(Loc) of orthogonal code Code_{ncm} at each period of Loc (code length) times of transmission periods as given in following Expression 2:

$$[ 2 ]$$

$${ψ}_{n c m} ( m ) = angle [ {OC}_{n c m} ( OC\_INDEX ) ] \qquad ( Expression 2 )$$

Here, angle(x) is an operator outputting the radian phase of real number x, and for example, angle(1)=0, angle(−1)=π, angle(j)=π/2, and angle(−j)=−π/2. The character “j” is an imaginary unit. The character “OC_INDEX” represents an orthogonal code element index indicating an element of orthogonal code sequence Code_{ncm}, and cyclically varies in the range of from 1 to Loc at each transmission period (Tr), as given by following Expression 3:

$$[ 3 ]$$

$$OC\_INDEX = mod ( m - 1 , Loc ) + 1. \qquad ( Expression 3 )$$

Here, mod (x, y) denotes a modulo operator and is a function that outputs the remainder after x is divided by y. Further, m=1, . . . , Nc. Nc denotes the number of transmission periods used by radar apparatus 10 for radar positioning (hereinafter referred to as “radar-transmission-signal transmission times”). Further, radar apparatus 10, for example, performs radar-transmission-signal transmission times Nc of transmission, where Nc is an integer multiple of Loc (e.g., by a factor of Ncode). For example, Nc=Loc×Ncode.

Further, code generator 104 outputs, in each transmission period (Tr), orthogonal code element index OC_INDEX to output switch 209 of radar receiver 200.

Phase rotator 105 includes, for example, phase shifters or phase modulators corresponding respectively to Nₜₓ transmission antennas 106. For example, phase rotator 105 applies phase rotation amount ψ_{ncm}(m) inputted from code generator 104 to a chirp signal inputted from radar transmission signal generator 101 at each transmission period Tr.

For example, phase rotator 105 applies phase rotation amount ψ_{ncm}(m) based on orthogonal code Code_{ncm} to ncmth transmission antenna Tx #ncm for the chirp signal inputted from radar transmission signal generator 101 at each transmission period Tr. Here, ncm=1, . . . , N_{CM} and m=1, . . . , Nc.

Outputs from phase rotators 105 to Nux transmission antennas 106 are amplified to predetermined transmission powers, for example, and then radiated into space from Nₜₓ transmission antennas 106 (e.g., transmission array antenna).

For example, phase rotation amounts ψ_{ncm}(m) are outputted from code generator 104 to phase rotator 105 at each mth transmission period Tr.

For example, first (ncm=1) phase rotator 105 (in other words, a phase shifter corresponding to first transmission antenna 106-1 (for example, Tx #1)) applies, at each transmission period Tr, phase rotation to the chirp signal generated in radar transmission signal generator 101 at each transmission period Tr as in following Expression 4. The output of first phase rotator 105 is transmitted from transmission antenna Tx #1. Here, cp(t) represents the chirp signal of mth transmission period Tr.

$$[ 4 ]$$

$$exp [ j {ψ}_{1} ( 1 ) ] cp ( t ) , exp [ j {ψ}_{1} ( 2 ) ] cp ( t ) , exp [ j {ψ}_{1} ( 3 ) ] cp ( t ) , … , exp [ j {ψ}_{1} ( Nc ) ] cp ( t ) \qquad ( Expression 4 )$$

A configuration example of radar transmitter 100 has been described above.

### [Configuration of Radar Receiver 200]

In FIG. 5, radar receiver 200 includes Na reception antennas 202 (also referred to as Rx #1 to Rx #Na, for example), which constitute an array antenna. Radar receiver 200 further includes Na antenna system processors 201-1 to 201-Na, constant false alarm rate (CFAR) section 211, code demultiplexer 212, direction estimator 213.

Each of reception antennas 202 receives a reflected wave signal that is a radar transmission signal reflected from a target object, and outputs the received reflected wave signal to the corresponding one of antenna system processors 201 as a reception signal.

Each of antenna system processors 201 includes reception radio 203 and signal processor 206.

Reception radio 203 includes mixer 204 and low pass filter (LPF) 205. Mixer 204 mixes the received reflected wave signal with a chirp signal inputted from radar transmission signal generator 101 which is a transmission signal. LPF 205 performs LPF processing on an output signal from mixer 204 to output a beat signal having a frequency depending on a delay time of the reflected wave signal. For example, as illustrated at part (b) of FIG. 6, the difference frequency between the frequency of a transmission chirp signal (transmission frequency-modulated wave) and the frequency of a reception chirp signal (reception frequency-modulated wave) is obtained as a beat frequency.

In each antenna system processor 201-z (where z is any of 1 to Na), signal processor 206 includes analog-to-digital (AD) converter 207, beat frequency analyzer 208, output switch 209, and Doppler analyzers 210.

The signal (for example, beat signal) outputted from LPF 205 is converted into discretely sampled data by AD converter 207 in signal processor 206.

Beat frequency analyzer 208 performs, in each transmission period Tr, FFT processing on N_{data} pieces of discretely sampled data obtained in a defined time range (range gate). Signal processor 206 thus outputs a frequency spectrum in which a peak appears at a beat frequency dependent on the delay time of the reflected wave signal (radar reflected wave). Note that, as the FFT processing, beat frequency analyzer 208 may perform multiplication by a window function coefficient such as the Han window or the Hamming window, for example. Radar apparatus 10 can suppress sidelobes that appear around the beat frequency peak by using the window function coefficient. In addition, when N_{data} pieces of discretely sampled data are not a power of 2, beat frequency analyzer 208 may include, for example, zero-padded data to obtain the FFT size of a power of 2 to perform FFT processing.

Here, a beat frequency response obtained from the mth chirp pulse transmission, which is outputted from beat frequency analyzer 208 in zth signal processor 206, is represented by RFT_{z}(f_{b}, m). Here, f_{b} denotes the beat frequency index and corresponds to an FFT index (bin number). For example, f_{b}=0, . . . , (N_{data}/2)−1, z=1, . . . , Na, and m=1, . . . , N_{C}. A beat frequency having smaller beat frequency index f_{b} indicates a shorter delay time of the reflected wave signal (for example, a shorter distance to the target object).

In addition, beat frequency index f_{b} may be converted into distance information R(f_{b}) using following Expression 5. Thus, in the following, beat frequency index f_{b} is also referred to as “distance index f_{b}.”

$$[ 5 ]$$

$$R ( {f}_{b} ) = \frac{{C}_{0}}{2 {B}_{w}} {f}_{b} \qquad ( Expression 5 )$$

Here, B_{w} denotes a frequency modulation bandwidth within the range gate for a chirp signal, and C₀ denotes the speed of light.

Output switch 209 performs selective switching to output the output of beat frequency analyzer 208 for each transmission period to OC_INDEXth Doppler analyzer 210 among Loc Doppler analyzers 210 based on orthogonal code element index OC_INDEX outputted from code generator 104. For example, output switch 209 selects OC_INDEXth Doppler analyzer 210 at mth transmission period Tr.

Signal processor 206 includes Loc Doppler analyzers 210-1 to 210-Loc. For example, data is inputted by output switch 209 to nocth Doppler analyzer 210 in each of Loc transmission periods (Loc×Tr). Accordingly, nocth Doppler analyzer 210 performs Doppler analysis for each distance index f_{b} using data of Ncode transmission periods among Nc transmission periods (for example, using beat frequency response RFT_{z}(f_{b}, m) inputted from beat frequency analyzer 208). Here, noc denotes the index of a code element, and noc=1, . . . , Loc.

For example, when Ncode is a power of 2, FFT processing may be applicable in the Doppler analysis. In this case, the FFT size is Ncode, and the maximum Doppler frequency at which no aliasing occurs and which is derived from the sampling theorem is ±1/(2Loc×Tr). Further, the Doppler frequency interval for Doppler frequency index fₛ is 1/(Ncode×Loc×Tr), and the range of Doppler frequency index fₛ is fₛ=−Ncode/2, . . . , 0, . . . , Ncode/2−1.

For example, output VFT_{z}^{noc}(f_{b}, fₛ) of Doppler analyzer 210 of zth signal processor 206 is given by following Expression 6. Here, j is the imaginary unit and z=1 to Na.

$$[ 6 ]$$

$$V F {T}_{𝓏}^{n o c} ( {f}_{b} , {f}_{s} ) = {\sum }_{s = 0}^{{N}_{code} - 1} {RFT}_{𝓏} ( {f}_{b} , {L}_{O C} \times s + n oc ) exp [ - j \frac{2 π {sf}_{s}}{{N}_{code}} ] \qquad ( Expression 6 )$$

Further, when Ncode is not a power of 2, zero-padded data may be included to perform FFT processing, with the data size (FFT size) being equal to a power of 2, for example.

The following description will be given of a case where Ncode is a power of 2, as an example.

In addition, for the FFT processing, Doppler analyzer 210 may perform multiplication by a window function coefficient such as the Han window or the Hamming window, for example. Radar apparatus 10 can suppress sidelobes generated around the beat frequency peak by applying a window function.

The processing in each component of signal processor 206 has been described above.

In FIG. 5, CFAR section 211 performs CFAR processing (for example, adaptive threshold judgement) using the outputs of Loc Doppler analyzers 210 in each of the first to Nath signal processors 206 and extracts distance indices f_{b_cfar} and Doppler frequency indices f_{s_cfar} that provide peak signals.

For example, CFAR section 211 performs power addition of outputs VFT_{z}^{noc}(f_{b}, fₛ) of Doppler analyzers 210 in first to Nath signal processors 206, for example, as given by following Expression 7, so as to perform two-dimensional CFAR processing in two dimensions formed by the distance axis and the Doppler frequency axis (corresponding to the relative velocity) or CFAR processing using two-dimensional and one-dimensional CFAR processing in combination. For example, processing disclosed in NPL 3 may be applied as the two-dimensional CFAR processing or the CFAR processing using two-dimensional and one-dimensional CFAR processing in combination.

$$[ 7 ]$$

$$PowerFT ( {f}_{b} , {f}_{s} ) = {\sum }_{𝓏 = 1}^{{N}_{a}} {\sum }_{noc = 1}^{{L}_{oc}} {\vert VF {T}_{𝓏}^{n o c} ( {f}_{b} , {f}_{s} ) \vert}^{2} \qquad ( Expression 7 )$$

CFAR section 211 adaptively sets a threshold and outputs, to code demultiplexer 212, distance index f_{b_cfar} and Doppler frequency index f_{s_cfar} that provide a reception power greater than the threshold, and reception power information PowerFT (f_{b_cfar}, f_{s_cfar}).

Next, an exemplary operation of code demultiplexer 212 will be described.

Code demultiplexer 212 performs separation processing of a code multiplexed signal based on distance index f_{b_cfar} and Doppler frequency index f_{s_cfar} extracted by CFAR section 211, for example.

For example, as given in following Expression 8, code demultiplexer 212 performs code demultiplexing processing on Doppler component VFTALL_{z}(f_{b_cfar}, f_{s_cfar}) that is the output of Doppler analyzer 210 corresponding to distance index f_{b_cfar} and Doppler frequency index f_{s_cfar} extracted by CFAR section 211.

$$[ 8 ]$$

$${DeMUL}_{z}^{n c m} ( {f}_{b \_ cfar} , {f}_{s \_ cfar} ) = {( {Code}_{n c m} )}^{*} \cdot {\{ α ( {f}_{s \_ cfar} ) ⊗ VFTAL {L}_{z} ( {f}_{b \_ cfar} , {f}_{s \_ cfar} ) \}}^{T} \qquad ( Expression 8 )$$

Here, DeMul_{z}^{ncm}(f_{b_cfar}, f_{s_cfar}) is an output (e.g., code demultiplexing result) resulting from code demultiplexing of the code multiplexed signal using orthogonal code Code_{ncm} for the output of distance index f_{b_cfar} and Doppler frequency index f_{s_cfar} of Doppler analyzer 210 in zth antenna system processor 201. Note that, z=1, . . . , Na and ncm=1, . . . , N_{CM}.

Further, in Expression 8,

operator“⊗” [9]

represents a product between elements of vectors having the same number of elements. For example, for nth order vectors A=[a₁, . . . , aₙ] and B=[b₁, . . . , bₙ], the product between the elements is expressed by following Expression 9:

$$[ 10 ]$$

$$A ⊗ B = [ {a}_{1} , … , {a}_{n} ] ⊗ [ {b}_{1} , … , {b}_{n} ] = [ {a}_{1} {b}_{1} , … , {a}_{n} {b}_{n} ] \qquad ( Expression 9 )$$

Further, in Expression 8,

operator “·” [11]

represents a vector dot product operator. In Expression 8, superscript “T” represents vector transposition, and superscript “*” (asterisk) represents a complex conjugate operator.

In Expression 8, “α(f_{s_cfar})” represents “Doppler phase correction vector.” Doppler phase correction vector α(f_{s_cfar}) corrects the Doppler phase rotation caused by a time difference between Doppler analyses of Loc Doppler analyzers 210 within Doppler aliasing range Dr when Doppler frequency index f_{s_cfar} extracted in CFAR section 211 is in an output range (in other words, Doppler range) of Doppler analyzers 210 that does not include Doppler aliasing, for example.

For example, Doppler phase correction vector α(f_{s_cfar}) is expressed by following Expression 10. For example, Doppler phase correction vector α(f_{s_cfar}) as given by Expression 10 is a vector having, as an element, a Doppler phase correction factor. The Doppler phase correction factor corrects phase rotations of Doppler components having Doppler frequency indices f_{s_cfar} and being within Doppler aliasing range Dr. The phase rotations are caused by the time lags of Tr, 2Tr, . . . , (Loc−1) Tr of the outputs of from output VFT_{z}²(f_{b_cfar}, f_{s_cfar}) of second Doppler analyzer 210 to output VFT_{z}^{Loc}(f_{b_cfar}, f_{s_cfar}) of Locth Doppler analyzer 210, for example, with reference to the Doppler analysis time for analysis on output VFT_{z}¹(f_{b_cfar}, f_{s_cfar}) of first Doppler analyzer 210.

$$[ 12 ]$$

$$α ( {f}_{s \_ cfar} ) = [ 1 , exp [ - j \frac{2 π {f}_{s \_ cfar}}{{N}_{c o d e}} \frac{1}{L o c} , exp [ - j \frac{2 π {f}_{s \_ cfar}}{{N}_{c o d e}} \frac{2}{L o c} , … , exp [ - j \frac{2 π {f}_{s \_ cfar}}{{N}_{c o d e}} \frac{L o c - 1}{L o c} ] \qquad ( Expression 10 )$$

Note that, VFTALL_{z}(f_{b_cfar}, f_{s_cfar}) in Expression 8 is a representation in vector format of component VFT_{z}^{noc}(f_{b_cfar}, f_{s_cfar}) (where noc=1, . . . , Loc) corresponding to distance index f_{b_cfar} and Doppler frequency index f_{s_cfar} extracted in CFAR section 211, the component being from among outputs VFT_{z}^{noc}(f_{b}, fₛ) of Loc Doppler analyzers 210 in zth antenna system processor 201, for example, as given by following Expression 11.

$$[ 13 ]$$

$${vFTALL}_{𝓏} ( {f}_{b \_ cfar} , {f}_{s \_ cfar} ) = [ V F {T}_{𝓏}^{1} ( {f}_{b \_ cfar} , {f}_{s \_ cfar} ) , V F {T}_{𝓏}^{2} ( {f}_{b \_ cfar} , {f}_{s \_ cfar} ) … , VF {T}_{𝓏}^{Loc} ( {f}_{b \_ cfar} , {f}_{s \_ cfar} ) ] \qquad ( Expression 11 )$$

An exemplary operation of code demultiplexer 212 has been described above. With reference to the configuration illustrated in FIG. 5, a description has been given of the operation of code demultiplexer 212 on the assumption that the maximum Doppler frequency at which no aliasing occurs and which is derived from the sampling theorem is ±1/(2Loc×Tr), and a target object detected by radar apparatus 10 is within this range.

Radar apparatus 10 may employ an arrangement of transmission antennas 106 and reception antennas 202 that can suppress grating lobes or sidelobes to increase angular resolution, for example, by increasing the array gain and increasing the aperture length by the virtual reception antenna.

Hereinafter, an example of the antenna arrangement of transmission antennas 106 and reception antennas 202, and an example of the direction estimation processing of direction estimator 213 in a case of application of each arrangement example will be described.

Note that, in the following arrangement example and variations, the arrangement of transmission antennas 106 may be replaced with the antenna arrangement of reception antennas 202, and the arrangement of reception antennas 202 may be replaced with the arrangement of transmission antennas 106. In radar apparatus 10, even when the antenna arrangement of transmission antennas 106 and the antenna arrangement of reception antennas 202 are replaced with each other, it is possible to obtain the same virtual reception antenna arrangement (in which virtual reception antenna numbers are changed) and obtain the same effects (for example, angular measurement performance) as those in the following arrangement example.

In addition, the horizontal direction and the vertical direction in the following arrangement example and variations may be interchanged. In the case of the antenna arrangement in which the horizontal direction and the vertical direction are replaced with each other, radar apparatus 10 can obtain a virtual reception antenna arrangement with the horizontal direction and the vertical direction being replaced with each other, and obtain an effect (for example, angular separation performance) of the following arrangement example in which the horizontal direction and the vertical direction are replaced with each other.

In addition, the horizontal direction and the vertical direction in the arrangement example do not have to strictly coincide with the horizontal direction and the vertical direction, and the entire arrangement example may be inclined at a predetermined angle while maintaining the relative positional relation between the transmission antennas and the reception antennas included in the arrangement example. Also in this case, since the relative positional relation between the transmission antennas and the reception antennas included in the arrangement example is maintained, the same effects can be obtained.

The antenna arrangement (for example, MIMO antenna arrangement) of radar apparatus 10 may be, for example, an arrangement satisfying the following arrangement conditions.

### [Arrangement Condition A]

The virtual reception antenna is arranged in oblique direction ψ. Here, the arrangement in oblique direction ψ is an arrangement in the direction of angle ψ with respect to the horizontal direction. Angle ψ with respect to the horizontal direction may be set, for example, in a range of 30°≤ψ≤60°. Also, the spacing of the virtual reception antennas arranged in oblique direction ψ includes spacing D_{d} of 0.5λ.

For example, the virtual reception antennas configured by the transmission and reception antennas of radar apparatus 10 may include a plurality of virtual reception antennas (e.g., corresponding to a first virtual reception antenna group) arranged in an oblique direction (e.g., a third direction) different from both the horizontal direction (e.g., corresponding to a first direction) and the vertical direction (e.g., corresponding to a second direction orthogonal to the first direction), where at least one of the spacings between two adjacent virtual reception antennas is 0.5λ (e.g., a defined value based on the wavelength of the radar transmission signal), thus satisfying Arrangement Condition A. For example, when transmission antenna spacing Dt and reception antenna spacing Dr have absolute value D_{d} (=|Dₜ−Dᵣ|) of a difference between Dₜ and Dᵣ of approximately 0.5λ (1×the defined value), or when absolute value D_{d} (=|Dₜ−Dᵣ|) of the difference between Dₜ and Dᵣ is an integer multiple of the spacing of approximately 0.5λ that is no less than twice the spacing (no less than twice the defined value), and either Dₜ or Dᵣ is approximately 0.5λ (1×the defined value), then at least one of the spacings between two adjacent virtual reception antennas is 0.5λ (e.g., the defined value based on the wavelength of the radar transmission signal).

Note that here, spacing D_{d} is set to 0.5λ, but the spacing may be, for example, approximately 0.5λ to 0.8λ. Spacing D_{d} may be set, for example, according to the horizontal or vertical viewing angle of radar apparatus 10. For example, when the horizontal or vertical viewing angle is a wide viewing angle of approximately ±70 degrees to 90 degrees, spacing D_{d} may be set to approximately 0.5λ. Alternatively, when the horizontal or vertical viewing angle is a narrow viewing angle of approximately ±20 degrees to 40 degrees, spacing D_{d} may be set to a spacing wider than 0.5λ (e.g., approximately 0.72). The setting of spacing D_{d} is the same for subsequent arrangement examples (or variations).

Note that λ represents the wavelength of the carrier frequency of the radar transmission signal. For example, when a chirp signal is used as the radar transmission signal, it is the wavelength of the center frequency in the frequency sweep band of the chirp signal.

By arranging the virtual reception antennas in oblique direction ψ according to Arrangement Condition A, the apertures in both the horizontal and vertical directions can be expanded. Also, in Arrangement Condition A, spacing D_{d} of approximately 0.5% is included to prevent uncertainty during phase variation detection by the virtual reception antennas arranged in oblique direction ψ.

Note that in the virtual reception antennas arranged in oblique direction ψ, phase information dependent on both the horizontal and vertical angles of arrival of the target object is detected, so when radar apparatus 10 acquires two-dimensional angle measurement information, it uses the phase information caused by the horizontal and vertical angles of arrival of the target object. Therefore, in addition to Arrangement Condition A, at least one of Arrangement Condition B and/or Arrangement Condition C, which will be described later, is used in combination.

### [Arrangement Condition B]

At least two of the virtual reception antennas include a virtual antenna arrangement of antennas lined up in the horizontal direction, and the spacing is denoted by D_{H} (hereinafter also referred to as “horizontal spacing”). Horizontal spacing D_{H} is set, for example, to λ/(2 sin ψ)≥D_{H}>λ/2.

For example, the virtual reception antennas configured by the transmission and reception antennas of radar apparatus 10 may include virtual reception antennas arranged in the horizontal direction, where at least one of the spacings between two adjacent virtual reception antennas in the horizontal direction is wider than 0.5λ, thus satisfying Arrangement Condition B.

Note that when D_{H}>2/(2 sin ψ), a grating lobe may be generated in a specific azimuth or elevation (azimuth/elevation) range. When the radar detection area is a wide-angle range, there may be an influence by erroneous detection due to grating lobes, but when the radar detection area is a relatively narrow area near the front, there is no influence by grating lobes and no impact on radar detection performance, so D_{H}>λ/(2 sin ψ) may be set. [Arrangement Condition C]

At least two of the virtual reception antennas include a virtual antenna arrangement of antennas lined up in the vertical direction, and the spacing is denoted by D_{V} (hereinafter also referred to as “vertical spacing”). Vertical spacing D_{V} is set, for example, to λ/(2 cos ψ)≥ D_{V}>λ/2.

For example, the virtual reception antennas configured by the transmission and reception antennas of radar apparatus 10 may include virtual reception antennas arranged in the vertical direction, where at least one of the intervals between two adjacent virtual reception antennas in the vertical direction is wider than 0.5λ, thus satisfying Arrangement Condition C.

Note that, when D_{V}>λ/(2 cos ψ), grating lobes may occur in a specific azimuth/elevation range. When the radar detection area is a wide-angle range, there is a possibility of an influence by erroneous detection due to grating lobes, but when the radar detection area is a relatively narrow area near the front, there is no influence by grating lobes, and no degradation impact on radar detection performance, so D_{H}>λ/(2 cos ψ) may be set.

Arrangement Condition B allows radar apparatus 10 to detect the horizontal arrival angle information on a target object. Additionally, Arrangement Condition C allows radar apparatus 10 to detect the vertical arrival angle information on the target object. Furthermore, in Arrangement Conditions B and C, since horizontal spacing D_{H}>λ/2 and vertical spacing D_{V}>λ/2 are set, the aperture lengths in the horizontal and vertical directions can be expanded. Moreover, although grating lobes may be included in the horizontal and vertical directions due to Arrangement Conditions B and C, radar apparatus 10 can eliminate the grating lobes by satisfying Arrangement Condition A and either Arrangement Condition B or C.

Hereinafter, examples of the aforementioned arrangement conditions will be described. The following describes examples of MIMO antenna arrangements that satisfy the aforementioned arrangement conditions, and examples of direction estimation results by computer simulation in those arrangement examples.

### Arrangement Example 1

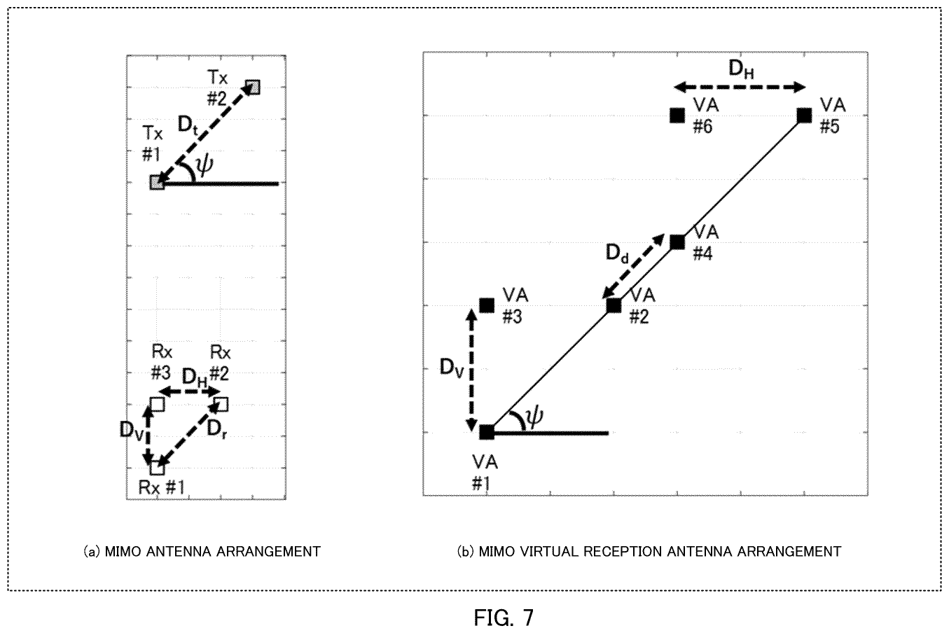

Part (a) in FIG. 7 illustrates an arrangement example (for example, a MIMO antenna arrangement example) of transmission antennas 106 (for example, represented by Tx) and reception antennas 202 (for example, represented by Rx) according to the aforementioned arrangement conditions. In the example shown in part (a) in FIG. 7, number N_{Tx} of transmission antennas is two (e.g., Tx #1 and Tx #2), and number Na of reception antennas is three (e.g., Rx #1, Rx #2, and Rx #3).

In part (a) in FIG. 7, N_{Tx} (=2) transmission antennas Tx #1 and #2 are arranged with spacing Dₜ in the oblique direction forming angle ψ with the horizontal direction (in part (a) in FIG. 7, ψ=45°).

Also, in part (a) in FIG. 7, at least two reception antennas Rx #1 and #2 of the Na (=3) reception antennas are arranged with spacing Dᵣ in the same oblique direction ψ in which transmission antennas Tx #1 and #2 are aligned.

Here, transmission antenna spacing Dₜ and reception antenna spacing Dᵣ may be set such that the absolute value D_{d} (=|Dₜ−Dᵣ|) of the difference between Dₜ and Dᵣ is approximately 0.5λ (D_{d}≈0.5λ). In part (a) in FIG. 7, for example, by setting spacing Dₜ=1.5λ and spacing Dᵣ=2, the virtual reception antenna arrangement includes spacing D_{d} of approximately 0.5λ (1×the defined value), satisfying Arrangement Condition A.

Additionally, in part (a) in FIG. 7, at least one of the other reception antennas (in the case of part (a) in FIG. 7, Rx #3) is arranged with horizontal spacing D_{H} or vertical spacing D_{V} with respect to reception antennas Rx #1 and Rx #2 arranged in the same oblique direction ψ in which transmission antennas Tx #1 and #2 are arranged.

For example, in part (a) in FIG. 7, reception antenna Rx #3 is positioned at horizontal spacing D_{H} from reception antenna Rx #2 and at vertical spacing D_{V} from reception antenna Rx #1. Here, horizontal spacing D_{H} is set to λ/(2 sin ψ)≥D_{H}>λ/2, satisfying Arrangement Condition B. Additionally, vertical spacing D_{V} is set to λ/(2 cos ψ)≥D_{V}>λ/2, satisfying Arrangement Condition C. In part (a) in FIG. 7, for example, when horizontal spacing D_{H} is set to λ×cos ψ(≈0.7λ) and vertical spacing D_{V} is set to λ×sin ψ (≈0.7λ), both Arrangement Conditions B and C are satisfied.

Thus, in part (a) in FIG. 7, transmission antennas Tx #1 (e.g., corresponding to the t1th antenna) and Tx #2 (e.g., corresponding to the t2th antenna) are arranged in oblique direction ψ (e.g., corresponding to the third direction). Also, in part (a) in FIG. 7, two reception antennas Rx #1 (e.g., corresponding to the r1th antenna) and Rx #2 (e.g., corresponding to the r2th antenna) are arranged in oblique direction ψ, and the absolute value of difference D_{d} between spacing Dᵣ (e.g., also referred to as spacing dr) between reception antennas Rx #1 and Rx #2 and spacing Dₜ (e.g., also referred to as spacing dt) between transmission antennas Tx #1 and Tx #2 is set to 0.5λ. Furthermore, in part (a) in FIG. 7, Rx #3 (e.g., corresponding to the r3th antenna) and Rx #2 are arranged at horizontal spacing D_{H} (a spacing wider than D_{d}=0.5λ) (e.g., also referred to as spacing dh) in the horizontal direction (e.g., corresponding to the second direction), and Rx #3 and Rx #1 are arranged at vertical spacing D_{V} (a spacing wider than D_{d}=0.5λ) (e.g., also referred to as spacing dv) in the vertical direction (e.g., corresponding to the first direction).

Note that, when number N_{Tx} of transmission antennas is three or more, at least two (e.g., Tx #1 and Tx #2) may satisfy the above arrangement conditions. Additionally, when number Na of reception antennas is three or more, at least three (e.g., Rx #1, Rx #2, and Rx #3) may satisfy the above arrangement conditions.

Part (b) of FIG. 7 illustrates an arrangement example of a virtual reception antenna obtained by the antenna arrangement illustrated in part (a) of FIG. 7.

Here, the arrangement of the virtual reception antennas may be expressed by following Expression 12, for example, based on the positions of transmission antennas 106 (e.g., the positions of feeding points or the phase centers of respective antennas) and the positions of reception antennas 202 (e.g., the positions of feeding points or the phase centers of respective antennas).

$$[ 14 ]$$

$$( Expression 12 )$$

$$\{ \begin{matrix}{X}_{V \_ \# k} = ( {X}_{T \_ \# [ ceil ( k / Na ) ]} - {X}_{T \_ \# 1} ) + ( {X}_{R \_ \# [ mod ( k - 1 , Na ) + 1 ]} - {X}_{R \_ \# 1} ) \\ {Y}_{V \_ \# k} = ( {Y}_{T \_ \# [ ceil ( k / Na ) ]} - {Y}_{T \_ \# 1} ) + ( {Y}_{R \_ \# [ mod ( k - 1 , Na ) + 1 ]} - {Y}_{R \_ \# 1} )\end{matrix}$$

Here, the horizontal and vertical position coordinates of transmission antenna 106 (e.g., Tx #n) are represented by (X_{T_#n}, Y_{T_#n}) (for example, n=1 to N_{Tx}), the position coordinates of reception antenna 202 (e.g., Rx #m) are represented by (X_{R_#m}, Y_{R_#m}) (for example, m=1 to Na), and the position coordinates of virtual reception antenna VA #k are represented by (X_{V_#k}, Y_{V_#k}) (for example, k=1 to N_{Tx}×Na).

In Expression 12, for example, VA #1 is expressed as the position reference (0, 0) of the virtual reception array.

In part (a) in FIG. 7, the arrangement of transmission antennas Tx #1 and Tx #2 is such that the position coordinates of Tx #2 are (X_{T_#2}, Y_{T_#2})=(X_{T_#1}+Dₜ×cos ψ, Y_{T_#1}+Dₜ×sin ψ), when based on the position coordinates (X_{T_#1}, Y_{T_#1}) of transmission antenna Tx #1. Also, in part (a) in FIG. 7, the arrangement of reception antennas Rx #1 to Rx #3 is such that (X_{R_#2}, Y_{R_#2})=(X_{R_#1}+Dᵣ×cos ψ, Y_{R_#1}+Dᵣ×sin ψ), and (X_{R_#3}, Y_{R_#3})=(X_{R_#1}+Dᵣ×cos ψ−D_{H}, Y_{R_#1}+D_{V}), when based on the position coordinates (X_{R_#1}, Y_{R_#1}) of reception antenna Rx #1. Furthermore, for example, in parts (a) and (b) in FIG. 7, when ψ=45°, horizontal spacing D_{H}=λ×cos ψ(=0.7%) and vertical spacing D_{V}=λ×sin ψ (=0.7%). Therefore, (X_{R_#3}, Y_{R_#3})=(X_{R_#1}, Y_{R_#1+2}×sin ψ). Accordingly, the position coordinates of virtual antennas VA #1 to #6 can be calculated from Expression 12. For example, the position coordinates of virtual antennas VA #1 to #6 are (X_{V_#1}, Y_{V_#1})=(0, 0), (X_{V_#2}, Y_{V_#2})=(Dᵣ×cos ψ, Dᵣ×sin ψ), (X_{V_#3}, Y_{V_#3})=(0, D_{V}), (X_{V_#4}, Y_{V_#4})=((Dᵣ+D_{d})×cos ψ, (Dᵣ+D_{d})×sin ψ), (X_{V_#5}, Y_{V_#5})=((2Dᵣ+D_{d})×cos ψ, (2Dᵣ+D_{d})×sin ψ)), (X_{V_#6}, Y_{V_#6})=((2Dᵣ+D_{d})×cos ψ−D_{H}, (2Dᵣ+D_{d})×sin ψ).

As shown in part (b) in FIG. 7, VA #1, VA #2, VA #4, and VA #5 are arranged in oblique direction, and the spacing between two adjacent VA #2 and VA #4 is D_{d} (=0.5λ). Also, as shown in part (b) in FIG. 7, VA #5 and VA #6 (or VA #2 and VA #3) are arranged in the horizontal direction, and the spacing between VA #5 and VA #6 (or the spacing between VA #2 and VA #3) in the horizontal direction is D_{H}, which is wider than D_{d}. Furthermore, as shown in part (b) in FIG. 7, VA #1 and VA #3 (or VA #4 and VA #6) are arranged in the vertical direction, and the spacing between VA #1 and VA #3 (or the spacing between VA #4 and VA #6) in the vertical direction is D_{V}, which is wider than D_{d}.

For example, in part (b) in FIG. 7, the virtual reception antennas include VA #1, VA #2, VA #4, and VA #5, which are arranged in oblique direction ψ satisfying Arrangement Condition A (e.g., corresponding to the first virtual reception antenna group), and VA #3 and VA #6, which are arranged in a direction parallel to oblique direction ψ (e.g., corresponding to the fifth direction) (e.g., corresponding to the second virtual reception antenna group). Additionally, in part (b) in FIG. 7, spacing D_{V} in the vertical direction between one virtual antenna (e.g., VA #1 or VA #5) included in VA #1, VA #2, VA #4, and VA #5 (the first virtual reception antenna group) and one virtual reception antenna included in VA #3 and VA #6 (e.g., the second virtual reception antenna group) is wider than the defined value (e.g., 0.5λ). For example, in part (b) in FIG. 7, horizontal spacing D_{V} between one virtual antenna (e.g., VA #2 or VA #5) included in VA #1, VA #2, VA #4, and VA #5 (first virtual reception antenna group) and one virtual reception antenna included in VA #3 and VA #6 (e.g., second virtual reception antenna group) is wider than the defined value (e.g., 0.5λ).

Thus, the virtual reception antennas shown in part (b) in FIG. 7 satisfy Arrangement Conditions A, B, and C.

Next, an example of direction estimation processing performed by direction estimator 213 in the case where above-described Arrangement Example 1 is applied will be described.

For example, direction estimator 213 performs direction estimation processing by generating virtual reception array correlation vector h(f_{b_cfar}, f_{s_cfar}) of transmission antenna 106 as shown in Expression 13 using reception signal DeMul_{z}^{ncm}(f_{b_cfar}, f_{s_cfar}) obtained by code separation processing on a code multiplexed signal transmitted from transmission antenna 106.

Virtual reception array correlation vector h(f_{b_cfar}, f_{s_cfar}) includes N_{Tx}×Na elements, the number of which is the product of number N_{Tx} of transmission antennas and number Na of reception antennas. Virtual reception array correlation vector h(f_{b_cfar}, f_{s_cfar}) is used in processing for performing, on reflected wave signals from a target object, direction estimation based on a phase difference between reception antennas 202. Here, z=1, . . . , Na.

In the MIMO antenna arrangement of Arrangement Example 1, N_{Tx}=2 and Na=3. Thus, virtual reception array correlation vector h(f_{b_cfar}, f_{s_cfar}) includes 6 elements, and the elements correspond respectively to reception signals of VA #1 to VA #6 in the virtual reception antenna arrangement illustrated in (b) of FIG. 7. For example, VA #1 corresponds to first element DeMul₁¹(f_{b_cfar}, f_{s_cfar} of column vector elements h(f_{b_cfar}, f_{s_cfar}). Similarly, the second to the sixth elements correspond respectively to the reception signals of VA #2 to VA #6.

$$[ 15 ]$$

$$h ( {f}_{b \_ cfar} , {f}_{s \_ cfar} ) = [ \begin{matrix}{DeMUL}_{1}^{1} ( {f}_{b \_ cfar} , {f}_{s \_ cfar} ) \\ {DeMUL}_{2}^{1} ( {f}_{b \_ cfar} , {f}_{s \_ cfar} ) \\ ⋮ \\ {DeMUL}_{Na}^{1} ( {f}_{b \_ cfar} , {f}_{s \_ cfar} ) \\ {DeMUL}_{1}^{2} ( {f}_{b \_ cfar} , {f}_{s \_ cfar} ) \\ ⋮ \\ {DeMUL}_{Na}^{2} ( {f}_{b \_ cfar} , {f}_{s \_ cfar} ) \\ ⋮ \\ {DeMUL}_{1}^{{N}_{Tx}} ( {f}_{b \_ cfar} , {f}_{s \_ cfar} ) \\ ⋮ \\ {DeMUL}_{Na}^{{N}_{Tx}} ( {f}_{b \_ cfar} , {f}_{s \_ cfar} )\end{matrix} ] \qquad ( Expression 13 )$$

Next, direction estimator 213 performs, in a below-described manner, the direction estimation processing in the horizontal and vertical directions using virtual reception array correlation vector h(f_{b_cfar}, f_{s_cfar}), which is a reception signal of the virtual reception array composed of the above-described transmission and reception antenna arrangement.

Direction estimator 213 multiplies virtual array correlation vector h(f_{b_cfar}, f_{s_cfar}) by array correction value h_cal_{[y]} that corrects the phase deviation and the amplitude deviation between the transmission array antennas and the reception array antennas, as given in following Expressions 14 and 15, thereby outputting virtual reception array correlation vector h_{after_cal}(f_{b_cfar}, f_{s_cfar}) in which the inter-antenna deviations are corrected. The direction estimation processing in the horizontal and vertical directions is performed based on phase differences of incoming reflected waves between the reception antennas. Here, y=1, . . . , (N_{Tx}×Na).

Note that, “CA” indicated in Expression 15 is a (N_{Tx}×Na)-order square matrix including an array correction coefficient for correcting the phase deviation and the amplitude deviation between the transmission antennas and the reception antennas, and a coefficient for reducing the influence of coupling of elements between the antennas. When the coupling between the antennas of the virtual reception array is negligible, CA is a diagonal matrix, and the diagonal components include array correction value h_cal_{[y]} that corrects the phase and amplitude deviations between the transmission antennas and the reception antennas.

Virtual reception array correlation vector h_{after_cal}(f_{b_cfar}, f_{s_cfar}), in which inter-antenna deviations are corrected, is a column vector composed of N_{Tx}×Na elements. Hereinafter, each element is denoted as h₁(f_{b_cfar}, f_{s_cfar}), . . . , h_{NTr×Na}(f_{b_cfar}, f_{s_cfar}) and used for explaining the direction estimation processing.

$$[ 16 ]$$

$${h}_{after \_ cal} ( {f}_{b \_ cfar} , {f}_{s \_ cfar} ) = CA \times h ( {f}_{b \_ cfar} , {f}_{s \_ cfar} ) = [ \begin{matrix}{h}_{1} ( {f}_{b \_ cfar} , {f}_{s \_ cfar} ) \\ {h}_{2} ( {f}_{b \_ cfar} , {f}_{s \_ cfar} ) \\ ⋮ \\ {h}_{{N}_{Tx} \times Na} ( {f}_{b \_ cfar} , {f}_{s \_ cfar} )\end{matrix} ] \qquad ( Expression 14 )$$

$$[ 17 ]$$

$$CA = [ \begin{matrix}{h\_cal}_{[ 1 ]} & 0 & ⋯ & 0 \\ 0 & {h\_cal}_{[ 2 ]} & ⋱ & ⋯ \\ ⋮ & ⋱ & ⋱ & 0 \\ 0 & ⋯ & 0 & {h\_cal}_{[ Nt \times Na ]}\end{matrix} ] \qquad ( Expression 15 )$$

Direction estimator 213 performs direction estimation in the horizontal and vertical directions using virtual reception array correlation vector h_{after_cal}(f_{b_cfar}, f_{s_cfar}) in which the inter-antenna deviations are corrected. In the horizontal and vertical direction estimation, direction estimator 213 varies, within predetermined angle ranges, azimuth direction θ and elevation direction φ in direction-of-arrival estimation evaluation function value P(θ, φ, f_{b_cfar}, f_{s_cfar}) to calculate a spatial profile, extracts a predetermined number of the maximum peak directions in descending order, and outputs the azimuth direction and elevation direction for respective maximum peaks as the direction-of-arrival estimation values. Here, θ and φ represent the azimuth angle and elevation angle with respect to the target object. For example, when antennas are arranged in the XZ plane (e.g., with the X-axis as the horizontal direction and the Z-axis as the vertical direction), the radar axis in a radar front direction (the direction perpendicular to the XZ plane) becomes the Y-axis, and the direction cosines of the X, Y, and Z axes with respect to the target object can be expressed as sin θ cos φ, cos θ cos φ, and sing, respectively.

Note that, there are various types of direction-of-arrival estimation evaluation function values P(θ, Φ, f_{b_cfar}, f_{s_cfar}) depending on direction-of-arrival estimation algorithms. For example, an estimation method using an array antenna disclosed in NPL 4 may be used. For example, the beamforming method can be expressed as following Expression 16. Here, superscript H denotes the Hermitian transpose operator. In addition, a technique such as Capon or MUSIC is also applicable.

$$[ 18 ]$$

$$P ( {θ}_{u} , {ϕ}_{v} , {f}_{b \_ cfar} , {f}_{s \_ cfar} ) = {\vert {a}^{H} ( {θ}_{u} , {ϕ}_{v} ) {h}_{after \_ cal} ( {f}_{b \_ cfar} , {f}_{s \_ cfar} ) \vert}^{2} \qquad ( Expression 16 )$$

Here, θᵤ is a value varied at predetermined azimuth interval β₁ within the azimuth range where direction-of-arrival estimation is performed. For example, θᵤ may be set as follows: θᵤ=θ min+uβ₁, where u=0, . . . , NU, and NU=floor[(θ max−θ min)/β₁]. Here, floor(x) is a function that returns the largest integer value not greater than real number x.

In addition, φᵥ is a value varied at predetermined elevation interval β₂ within the elevation range where direction-of-arrival estimation is performed. For example, φᵥ may be set as follows: φᵥ=φ min+vβ₂, where v=0, . . . , NV, and NV=floor[(φ max−φ min)/β₂].

Here, direction vector α (θᵤ, φᵥ) is an (N_{Tx}×Na)th order dimensional column vector with elements of complex responses of the virtual reception antenna obtained when radar reflected waves arrive from azimuth direction θ and elevation direction φ. Complex response α(θᵤ, φᵥ) of the virtual reception antenna represents phase differences calculated geometrically and optically for the element spacings between the antennas. Note that the normal direction of a normal to the front surface is referred to as a reference (azimuth θ=0°, elevation φ=0°) with respect to the antenna surface illustrated in Arrangement Example 1.

### <Example of Direction Estimation Result of Arrangement Example 1>

Next, an example of a direction estimation result (computer simulation result) in the case where the antenna arrangement according to above-described Arrangement Example 1 is applied will be described.

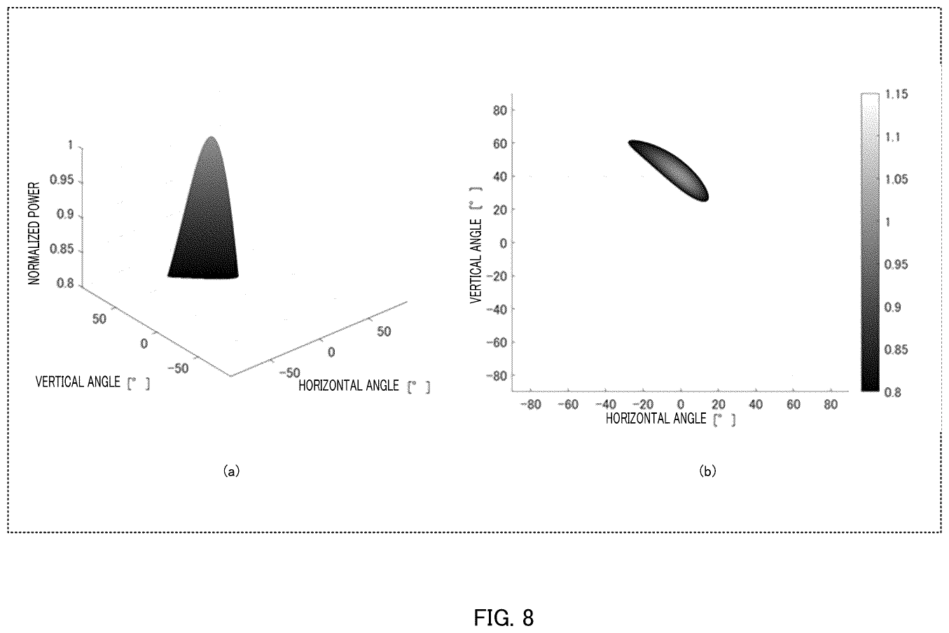

Parts (a) and (b) in FIG. 8 show examples of angle measurement results obtained by the beamforming method when receiving target object reflected waves from 0° in the horizontal direction and 40° in the vertical direction in the MIMO radar antenna arrangement shown in part (a) in FIG. 7. The direction estimation results shown in parts (a) and (b) in FIG. 8 are plots of the outputs of the direction-of-arrival estimation evaluation function values within the range of ±90 degrees in the horizontal direction and within the range of ±90 degrees in the vertical direction. In part (a) in FIG. 8, the abscissa represents the horizontal and vertical angles, and the ordinate represents the normalized power values in those two-dimensional directions in a three-dimensional manner. Part (b) in FIG. 8 is a view from above of part (a) in FIG. 8, showing an example of normalized power values in two-dimensional directions with the abscissa as the horizontal direction and the ordinate as the vertical direction, displayed as a heat map, with power values indicated in grayscale.

From parts (a) and (b) in FIG. 8, it can be seen that the main beam is directed at 0° in the horizontal direction and 40° in the vertical direction, and no grating lobes are generated. In the case of the MIMO radar antenna arrangement shown in part (a) in FIG. 7, the beam width is approximately 23° in the horizontal direction and approximately 24° in the vertical direction (in the case of a Fourier beam pattern directed at horizontal 0° and vertical) 0°. Therefore, in the antenna arrangement of part (a) in FIG. 7, compared to the antenna arrangement of FIG. 1, the 3 dB beam width in the horizontal direction is reduced by 62% (=23/37), and the 3 dB beam width in the vertical direction is reduced by 41% (=24/59), which is expected to improve the two-dimensional angle measurement accuracy in the horizontal and vertical directions (e.g., an accuracy improvement effect of about 1.6 to 2.5 times).

As described above, an example of the direction estimation result (computer simulation result) in Arrangement Example 1 and the effect of Arrangement Example 1 have been described.

In FIG. 5, direction estimator 213 may output, for example, the direction estimation result, and may further output, as a positioning result, distance information based on the distance index f_{b_cfar}(for example, information converted based on Expression 5), and Doppler velocity information of the target object based on Doppler frequency index f_{b_cfar} of the target object.

Following Expression 17 may be used to convert Doppler frequency index f_{s_cfar} into relative velocity component v_{d}(f_{s_cfar}). Here, λ is the wavelength of the carrier frequency of an RF signal outputted from a transmission radio (not illustrated). Further, Δ_{f} denotes the Doppler frequency interval in FFT processing performed in Doppler analyzer 210. For example, in the present embodiment, Δ_{f}=1/{Loc×N_{code}×Tr}.

$$[ 19 ]$$

$${v}_{d} ( {f}_{s \_ cfar} ) = \frac{λ}{2} {f}_{s \_ cfar} {Δ}_{f} \qquad ( Expression 17 )$$

The exemplary operation of radar apparatus 10 has been described above.

As described above, in Arrangement Example 1, by satisfying Arrangement Condition A and Arrangement Condition B or C in the MIMO antenna arrangement, two-dimensional arrival angle information on a target object with suppressed (or eliminated) grating lobes can be obtained. In Arrangement Example 1, by arranging the MIMO antennas to expand the virtual antennas in oblique direction ψ, the aperture surface in the vertical and horizontal directions can be expanded, and the two-dimensional angle measurement accuracy in the horizontal and vertical directions can be improved. This allows for an antenna arrangement capable of suppressing grating lobes while widening the element spacing in at least one of the vertical and/or horizontal directions, even under conditions where the number of antennas is a predetermined number, thereby improving the angle measurement accuracy (or resolution) in the horizontal and vertical directions in radar apparatus 10.

In the MIMO antenna arrangement of Arrangement Example 1, in addition to the virtual reception antennas arranged in oblique direction ψ that satisfy Arrangement Condition A (in part (b) in FIG. 7, VA #1, #2, #4, and #5), virtual reception antennas (VA #3 and VA #6 in part (b) in FIG. 7) arranged in oblique direction ψ at positions different from the arrangement positions of these virtual reception antennas are included. This allows for the application of a simplified two-dimensional angle measurement method (hereinafter referred to as “simplified two-dimensional angle measurement method”) in direction estimator 213, which can significantly reduce the two-dimensional angle measurement processing amount compared to the aforementioned two-dimensional Fourier beamforming angle measurement method. An example of the simplified two-dimensional angle measurement method will be described later.

It should be noted that the antenna arrangement of Arrangement Example 1 is not limited to the antenna arrangement shown in part (a) in FIG. 7. For example, in Arrangement Example 1, additional antennas may be added to at least one of transmission antenna 106 and/or reception antenna 202 in the antenna arrangement shown in part (a) in FIG. 7. When the number of transmission antennas 106 or reception antennas 202 increases, for example, a virtual reception antenna is additively added at the position indicated by Expression 12. For example, another virtual reception antenna is added to the virtual reception antenna arrangement shown in part (b) in FIG. 7. Even in the case of the antenna arrangement including Arrangement Example 1, the effects described in above-mentioned Arrangement Example 1 are retained, and the same effects as those of Arrangement Example 1 can be obtained.

In addition, for example, by further adding an antenna to the antenna configuration of Arrangement Example 1, the grating lobe level or the sidelobe level suppressed is more likely to be further suppressed in addition to the effects described with reference to above-described Arrangement Example 1. Accordingly, erroneous detection at the time of angle measurement in radar apparatus 10 can be reduced, and the angular measurement performance can be improved. Note that the addition of the antenna can be similarly applied to the following arrangement examples or variations, and the same effects can be obtained.

Below, an example will be described in which the number of at least one of transmission antenna 106 and/or reception antenna 202 is further increased in the antenna arrangement of Arrangement Example 1 (e.g., part (a) in FIG. 7). Note that the addition of an antenna can be similarly applied to subsequent arrangement examples or variations, and the same effects can be obtained.

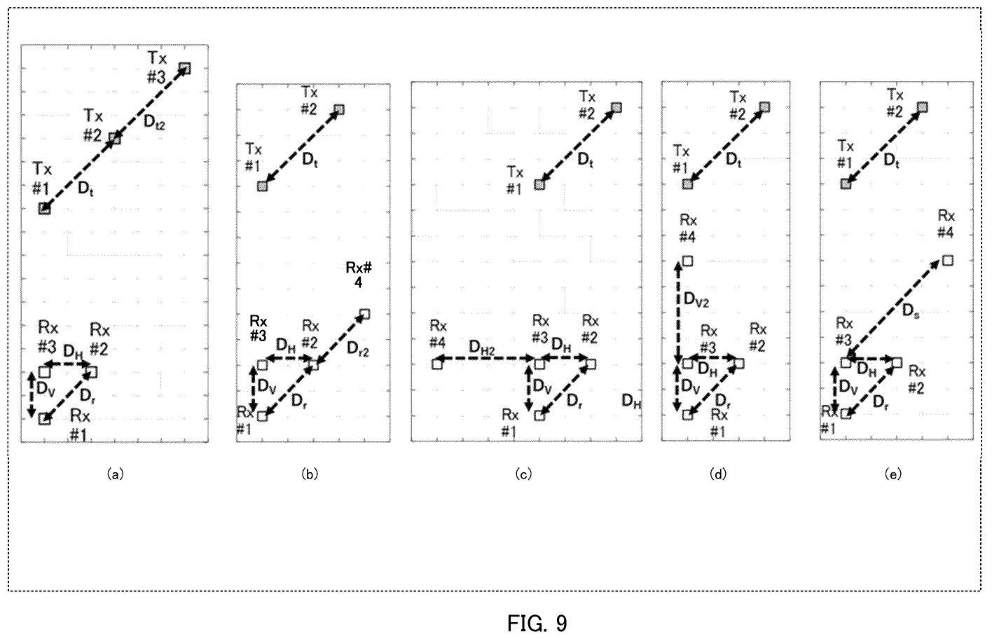

Part (a) in FIG. 9 is an example of an arrangement in which transmission antenna Tx #3 is further added to the antenna arrangement shown in part (a) in FIG. 7. In part (a) in FIG. 9, Tx #3 is arranged with spacing Dₜ₂ in oblique direction ψ with respect to Tx #2. Part (b) in FIG. 9 is an example of an arrangement in which reception antenna Rx #4 is further added to the antenna arrangement shown in part (a) in FIG. 7. In part (b) in FIG. 9, Rx #4 is arranged with spacing Dᵣ₂ in oblique direction ψ with respect to Rx #2.

The antenna arrangements in parts (a) and (b) of FIG. 9 increase the number of virtual reception antennas (not shown) arranged in oblique direction ψ that satisfy Arrangement Condition A, allowing further expansion of the apertures in both the horizontal and vertical directions, thereby improving the angle measurement performance in both the horizontal and vertical directions.

Note that in part (a) in FIG. 9, spacing Dₜ₂ between Tx #3 and Tx #2 is shown as being equal to spacing Dₜ between Tx #1 and Tx #2, but it is not limited to this, and the same effect can be obtained even when spacing Dₜ₂ is different from spacing Dₜ. Similarly, in part (b) in FIG. 9, spacing Dᵣ₂ between Rx #4 and Rx #2 is shown as being equal to spacing Dᵣ between Rx #1 and Rx #2, but it is not limited to this, and the same effect can be obtained even when spacing Dᵣ₂ is different from spacing Dᵣ.

Part (c) in FIG. 9 is an example of an arrangement in which reception antenna Rx #4 is further added to the antenna arrangement shown in part (a) in FIG. 7. In part (c) in FIG. 9, Rx #4 is arranged with spacing D_{H2} to be aligned in a row in the horizontal direction with respect to Rx #3. For example, spacing D_{H2} may be set to be greater than 2. The antenna arrangement shown in part (c) in FIG. 9 allows for an increase in virtual reception antennas arranged horizontally that satisfy Arrangement Condition B, further expanding the horizontal aperture and improving horizontal angle measurement performance.

Note that in part (c) in FIG. 9, spacing D_{H2} between Rx #4 and Rx #3 is shown as different from spacing D_{H} between Rx #2 and Rx #3, but it is not limited to this, and the same effect can be obtained even when spacing D_{H2} is the same as spacing D_{H}. Furthermore, for example, by setting spacing D_{H2} and spacing D_{H} to be coprime, the intervals at which grating lobes occur can be varied, improving the effect of suppressing grating lobes and resulting in a more suitable arrangement.

Also, the antenna arrangement shown in part (c) in FIG. 9 is an arrangement with the addition of reception antenna 202 (Rx #4) to the antenna arrangement shown in part (a) in FIG. 7, but it is not limited to this, and for example, transmission antenna 106 may be added. For example, the same effect can be obtained in an arrangement where transmission antenna Tx #3 (not shown) is added with spacing D_{H2} to be aligned in a row horizontally with respect to transmission antenna Tx #1 or Tx #2.

Part (d) in FIG. 9 is an example of an arrangement with the further addition of reception antenna Rx #4 to the antenna arrangement shown in part (a) in FIG. 7. In part (d) in FIG. 9, Rx #4 is arranged at spacing D_{V2} to be aligned in a row vertically with respect to Rx #3. For example, spacing D_{V2} may be set to be greater than 2. The antenna arrangement shown in part (d) in FIG. 9 allows for an increase in virtual reception antennas arranged vertically that satisfy Arrangement Condition C, further expanding the vertical aperture and improving vertical angle measurement performance.

Note that in part (d) in FIG. 9, spacing D_{V2} between Rx #4 and Rx #3 is shown as different from spacing D_{V} between Rx #1 and Rx #3, but it is not limited to this, and the same effect can be obtained even when spacing D_{V2} is the same as spacing D_{V}. Furthermore, for example, by setting spacing D_{V2} and spacing D_{V} to be coprime, the intervals at which grating lobes occur can be varied, improving the effect of suppressing grating lobes and resulting in a more suitable arrangement.

Also, the antenna arrangement shown in part (d) in FIG. 9 is an arrangement with the addition of reception antenna 202 (Rx #4) to the antenna arrangement shown in part (a) in FIG. 7, but it is not limited to this, and for example, transmission antenna 106 may be added. For example, the same effect can be obtained in an arrangement where transmission antenna Tx #3 (not shown) is added at spacing D_{V2} to be aligned in a row vertically with respect to transmission antenna Tx #1 or Tx #2.

Part (e) in FIG. 9 is an example of an arrangement with the further addition of reception antenna Rx #4 to the antenna arrangement shown in part (a) in FIG. 7. In part (e) in FIG. 9, Rx #4 is arranged with spacing Dₛ to be aligned in a row in oblique direction ψ with respect to another reception antenna Rx #3, different from Rx #1 and Rx #2, which constitute virtual reception antennas satisfying Arrangement Condition A. For example, spacing Dₛ may be set to be greater than λ. The antenna arrangement shown in part (e) in FIG. 9 allows for an increase in virtual reception antennas arranged in oblique direction ψ, further expanding the apertures in both the horizontal and vertical directions, thereby improving angle measurement performance in both directions.

Note that in part (e) in FIG. 9, spacing Dₛ between Rx #3 and Rx #4 is shown as different from spacing Dₜ between Tx #1 and Tx #2, but it is not limited to this, and the same effect can be obtained even when spacing Dₛ is the same as spacing Dₜ. For example, by setting spacing Dₛ and spacing Dₜ to be coprime, the intervals at which grating lobes occur can be varied, improving the effect of suppressing grating lobes and resulting in a more suitable arrangement.

Also, the antenna arrangement shown in part (e) in FIG. 9 is an arrangement with the addition of reception antenna 202 (Rx #4) to the antenna arrangement shown in part (a) in FIG. 7, but it is not limited to this. For example, the same effect can be obtained in an arrangement where a transmission antenna is added with spacing Dₛ to be aligned in a row in oblique direction ψ with respect to another transmission antenna 106, different from the transmission antennas constituting virtual reception antennas satisfying Arrangement Condition A. Note that in FIG. 9, D_{d} is 1 times the defined value.

In order to increase a detection range of radar apparatus 10, it is effective to use an antenna having a high gain. For example, the antenna gain can be increased by narrowing the directivity (beam width) of the antenna. The directivity of the antenna becomes narrower, for example, as the aperture surface of the antenna is widened. Thus, the narrower the directivity of the antenna, the larger the antenna size is likely to become. For example, in a radar apparatus configured to be mounted on a vehicle (also referred to as an in-vehicle radar, for example) or the like, a sub-array antenna configured by arranging a plurality of antenna elements in the vertical direction may be used in order to narrow directivity in the vertical direction. By narrowing the directivity in the vertical direction by the sub-array antenna, the antenna gain in the vertical direction can be increased, and a reflected wave in an unnecessary direction such as a direction toward a road surface can be reduced. Here, the vertical direction is a height direction of the vehicle on which the radar apparatus is mounted (or installed). The horizontal direction is a straight-traveling direction of the vehicle, a direction orthogonal to the straight-traveling direction of the vehicle, or a direction orthogonal to the height direction of the vehicle.

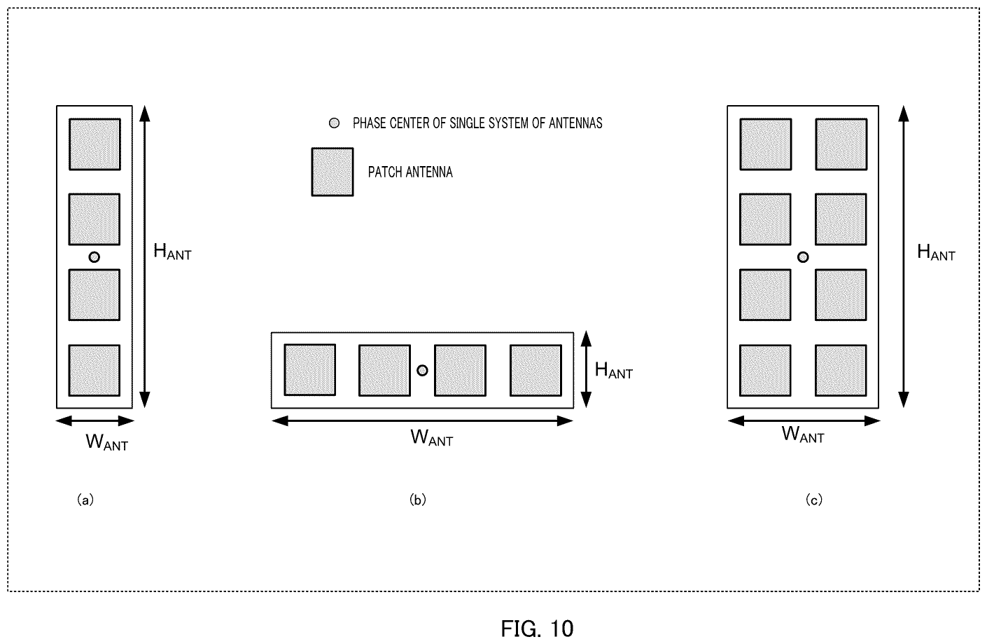

Part (a) in FIG. 10 shows an example of a sub-array in which four planar patch antennas are arranged in the vertical direction (the upper-lower direction in part (a) in FIG. 10) and one element is arranged in the horizontal direction (the lateral direction in part (a) in FIG. 10). Part (b) in FIG. 10 shows an example of a sub-array in which one planar patch antenna is arranged in the vertical direction (the upper-lower direction in part (b) in FIG. 10) and four elements are arranged in the horizontal direction (the lateral direction in part (b) in FIG. 10). Part (c) in FIG. 10 shows an example of a sub-array in which four planar patch antennas are arranged in the vertical direction (the upper-lower direction in part (c) in FIG. 10) and two elements are arranged in the horizontal direction (the lateral direction in part (c) in FIG. 10).

In FIG. 10, HANT indicates the antenna size in the vertical direction, and WANT indicates the antenna size in the horizontal direction. Note that the configuration of the sub-array is not limited to the configurations illustrated in FIG. 10, and for example, the number of elements in the vertical direction and the horizontal direction may be different from the numbers illustrated in FIG. 10.

When using such a sub-array antenna as a single antenna for transmission antenna 106 or reception antenna 202, it is difficult to arrange each antenna at spacings narrower than the size of the sub-array antenna.

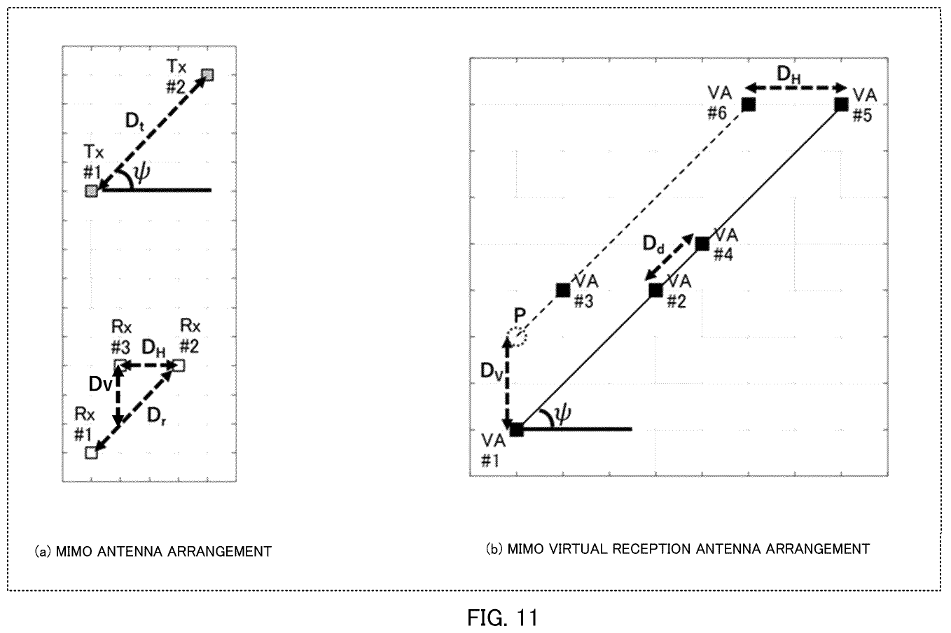

For example, when arranging the sub-array antenna shown in part (a) in FIG. 10, the size of the sub-array antenna may be equal to or greater than one wavelength in the vertical direction, so an antenna arrangement with a vertical antenna spacing wider by one wavelength or more may be applied. For example, since transmission antennas 106 does not vertically overlap one another and reception antennas 202 does not vertically overlap one another in FIGS. 11, 14, 16, and 17 described later, it is possible to arrange sub-array antennas having a large vertical size as shown in part (a) in FIG. 10.

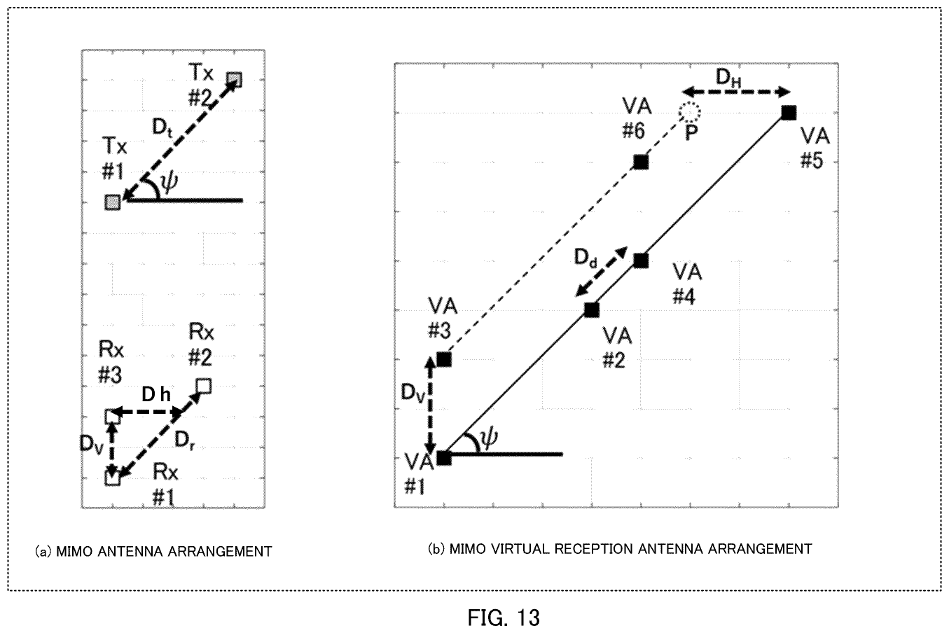

For example, when arranging the sub-array antenna shown in part (b) in FIG. 10, the size of the sub-array antenna may be equal to or greater than one wavelength in the horizontal direction, so an antenna arrangement with a horizontal antenna spacing wider by one wavelength or more may be applied. For example, the transmission antennas in each antenna arrangement described later, or the reception antennas shown in FIGS. 13, 17, and 19 described later, are arranged such that transmission antennas 106 do not horizontally overlap one another and reception antennas 202 do not horizontally overlap one another, making it possible to arrange sub-array antennas having a large horizontal size as shown in part (b) in FIG. 10.

For example, when arranging the sub-array antenna shown in part (c) in FIG. 10, the size of the sub-array antenna may be equal to or greater than one wavelength in both the horizontal and vertical directions. An antenna arrangement with a horizontal and vertical antenna spacing wider by one wavelength or more may be applied. For example, since transmission antennas in each antenna arrangement described later can be arranged at wide spacings in the horizontal and vertical directions, it is possible to arrange sub-array antennas having a large horizontal and vertical size as shown in part (c) in FIG. 10.

When using sub-array antennas as transmission antenna 106 or reception antenna 202 as described above, not only the aforementioned effects but also an effect of improving the directivity gain of the antenna can be obtained.

### [Variation of Arrangement Example 1]

Note that the same effect can be obtained even when Arrangement Example 1 is modified as follows. The following describes variations of Arrangement Example 1.

Part (a) in FIG. 11 is a diagram showing a variation of the MIMO antenna arrangement of transmission antennas 106 and reception antennas 202 related to Arrangement Condition 1. In the example shown in part (a) in FIG. 11, number N_{Tx} of transmission antennas is two (e.g., Tx #1 and Tx #2), and number Na of reception antennas is three (e.g., Rx #1, Rx #2, and Rx #3).

Part (b) in FIG. 11 is a diagram showing an example of the arrangement of virtual reception antennas obtained by the antenna arrangement shown in part (a) in FIG. 11. The arrangement of virtual reception antennas is calculated by applying Expression 12 based on the antenna arrangement shown in part (a) in FIG. 11.

In part (a) in FIG. 11, N_{Tx} (=2) transmission antennas Tx #1 and Tx #2 are arranged at spacing Dₜ in the oblique direction at angle ψ (ψ=45° in the example of FIG. 11) formed with the horizontal direction. Also, at least two of Na (=3) reception antennas 202, Rx #1 and Rx #2, are arranged with spacing Dᵣ in the same oblique direction ψ as the direction in which transmission antennas Tx #1 and Tx #2 are arranged.

Here, transmission antenna spacing Dₜ and reception antenna spacing Dᵣ may be set such that absolute value D_{d} (=|Dₜ−Dᵣ|) of the difference between Dₜ and Dᵣ is approximately 0.5λ (D_{d}≈0.5λ) (1×the defined value). In FIG. 11, for example, when spacing Dₜ is set to 2λ and spacing Dᵣ is set to 1.5λ, the virtual reception antenna arrangement includes spacing D_{d} of approximately 0.5λ, satisfying Arrangement Condition A.

Also, in part (a) in FIG. 11, reception antenna Rx #3 is arranged at a position spaced by spacing D_{H} horizontally from reception antenna Rx #2. Reception antenna Rx #3 is arranged in a fourth direction different from the horizontal, vertical, and oblique directions from reception antenna Rx #1. Note that reception antenna Rx #3 is arranged at a position spaced by spacing D_{H} horizontally from oblique direction ψ and at a position spaced by spacing D_{V} vertically. Here, by setting horizontal spacing D_{H}=λ/(2 sin ψ)≈0.7λ, Arrangement Condition B is satisfied. In part (a) in FIG. 11, reception antenna Rx #3 is not arranged to be aligned in a row vertically with spacing D_{V} from reception antenna Rx #1 or Rx #2, so it does not satisfy Arrangement Condition C.

Additionally, for example, in part (b) in FIG. 11, the difference in aperture length between VA #1, VA #2, VA #4, and VA #5 (e.g., the first virtual reception antenna group) and VA #3 and VA #6 (e.g., the second virtual reception antenna group) (e.g., the difference between VA3 to VA6 and VAI to VA5) may be set to be equal to a predetermined multiple of a defined value (e.g., 0.5λ).

Note that, when number N_{Tx} of transmission antennas is three or more, at least two (e.g., Tx #1 and Tx #2) may satisfy the above arrangement conditions. Additionally, when number Na of reception antennas is three or more, at least three (e.g., Rx #1, Rx #2, and Rx #3) may satisfy the above arrangement conditions.

An example of the direction estimation processing in direction estimator 213 performed when the above-described antenna arrangement is applied will be described. For example, direction estimator 213 performs direction estimation processing by generating virtual reception array correlation vector h(f_{b_cfar}, f_{s_cfar}) of transmission antenna 106, as shown in Expression 13, using received signal DeMul_{z}^{ncm}(f_{b_cfar}, f_{s_cfar}) obtained by code separation processing on a code multiplexed signal transmitted from transmission antenna 106. The operation of the direction estimation processor is similar to the operation performed when Arrangement Example 1 is used, and its description is omitted.

### <Example of Direction Estimation Result of Variation of Arrangement Example 1>

Next, an example of a direction estimation result (computer simulation result) obtained when the antenna arrangement according to the variation of Arrangement Example 1 is applied will be described.

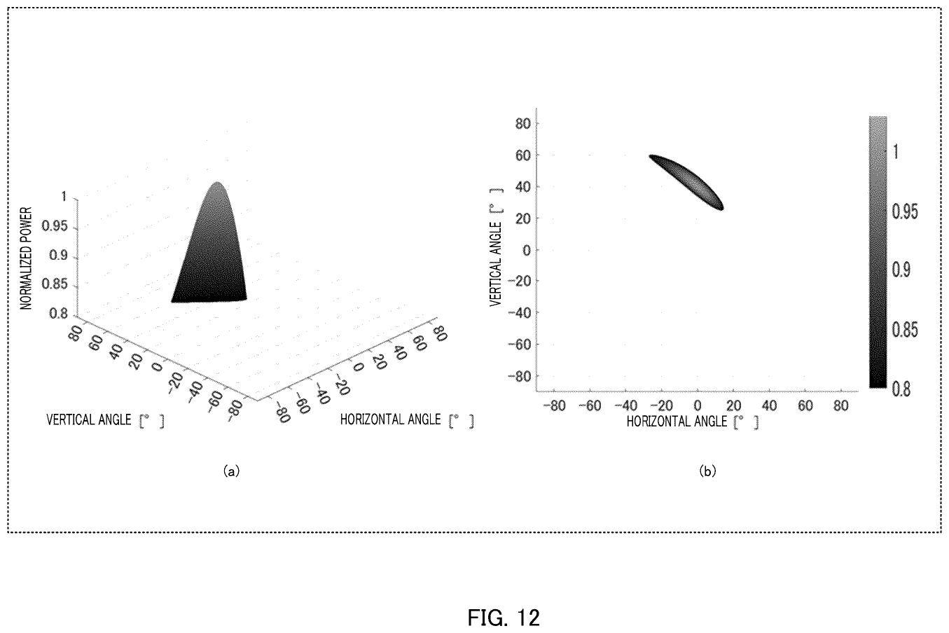

Parts (a) and (b) of FIG. 12 show examples of angle measurement results obtained by the beamforming method when receiving target object reflection waves from 0° in the horizontal direction and 40° in the vertical direction in the antenna arrangement of the MIMO radar shown in part (a) in FIG. 11. Parts (a) and (b) of FIG. 12 are plots obtained under similar target object conditions as the angle measurement results of Arrangement Example 1 (e.g., parts (a) and (b) of FIG. 8) and using similar graphs.

From parts (a) and (b) of FIG. 12, it can be seen that the main beam is directed at 0° in the horizontal direction and 40° in the vertical direction, and no grating lobes are generated. In the case of the antenna arrangement of the MIMO radar shown in part (a) in FIG. 11, the beam width is approximately 17° in the horizontal direction and approximately 18° in the vertical direction (in the case of a Fourier beam pattern directed at 0° in the horizontal direction and 0° in the vertical direction). Therefore, in the antenna arrangement of part (a) in FIG. 11, compared to the antenna arrangement of FIG. 1, the 3 dB beam width in the horizontal direction is reduced by 46% (=17/37), and the 3 dB beam width in the vertical direction is reduced by 31% (=18/59), leading to an expected improvement in the two-dimensional angle measurement accuracy in the horizontal and vertical directions (e.g., an accuracy improvement effect of approximately 2.2 to 3.3 times).

Thus, in the antenna arrangement according to the variation of Arrangement Example 1, by satisfying Arrangement Conditions A and B, similar effects to those in Arrangement Example 1 can be obtained.

Note that, in FIG. 11, the case where Arrangement Conditions A and B are satisfied has been described, but the present disclosure is not limited to this, and at least one of Arrangement Conditions B and C may be satisfied in addition to Arrangement Condition A. Part (a) in FIG. 13 is an example of an antenna arrangement that satisfies Arrangement Conditions A and C. For example, as shown in part (a) in FIG. 13, Rx #2 (e.g., corresponding to the r2th antenna) and Rx #3 (e.g., corresponding to the r3th antenna) are arranged in a direction (e.g., corresponding to the fourth direction) different from the vertical, horizontal, and oblique direction. Note that Rx #1 (e.g., corresponding to the r1th antenna) and Rx #3 (e.g., corresponding to the r3th antenna) are arranged in the vertical direction (e.g., corresponding to the second direction). Note that reception antenna Rx #3 is arranged at a position spaced by spacing D_{H} in the horizontal direction and spacing D_{V} in the vertical direction from oblique direction ψ. Part (b) in FIG. 13 is a diagram showing an example of the arrangement of virtual reception antennas obtained by the antenna arrangement shown in part (a) in FIG. 13. For example, in part (b) in FIG. 13, the difference in aperture length between VA #1, VA #2, VA #4, and VA #5 (e.g., the first virtual reception antenna group) and VA #3 and VA #6 (e.g., the second virtual reception antenna group) (e.g., the difference between VA3 to VA6 and VAI to VA5) may be set to be equal to a predetermined multiple of a defined value (e.g., 0.5λ). Even in the antenna arrangement shown in FIG. 13, similar effects to those in Arrangement Example 1 can be obtained, and grating lobes can be suppressed.

### [Example of Operation of Simplified Two-Dimensional Angle Measurement Method]

Hereinafter, an example of operation performed when the simplified two-dimensional angle measurement method is applied in direction estimator 213 will be described.

(1) Direction estimator 213 performs one-dimensional FFT processing using the received signals of virtual reception antennas arranged in oblique direction ψ that satisfy Arrangement Condition A, and calculates spatial spectrum H_{A}(m). Here, m=1, . . . , N_{FFT}, and N_{FFT} indicates the FFT size.

Then, direction estimator 213 extracts FFT index m_{peakA}, which is the peak on spatial spectrum H_{A}(m). Here, m_{peakA} is index m at which H_{A}(m) is maximized. For example, virtual reception antennas VA #1, VA #2, VA #4, and VA #5 shown in part (b) in FIG. 7 satisfy Arrangement Condition A, and VA #2 and VA #4 are arranged with spacing D_{d} (e.g., 0.5%). Direction estimator 213, for example, sets spacing D_{d} as the spatial sampling interval and performs one-dimensional FFT processing on the received signals of the virtual reception antennas arranged in oblique direction ψ that satisfy Arrangement Condition A.

When there are no virtual reception antennas with spacing D_{d}, direction estimator 213 may perform FFT processing with zero padding. For example, based on the received signals h_{VA #1}, h_{VA #2}, h_{VA #4}, and h_{VA #5} of virtual reception antennas VA #1, VA #2, VA #4, and VA #5 arranged obliquely satisfying Arrangement Condition A in part (b) in FIG. 7, the received vector ha is expressed as in following Expression 18. Note that received signals h_{VA #n} represents the nth element of virtual reception array correlation vector h(f_{b_cfar}, f_{s_cfar}).

$$[ 20 ]$$

$${h}_{A} = {[ \begin{matrix}{h}_{VA \#1} & 0 & {h}_{VA \#2} & {h}_{VA \#4} & 0 & {h}_{VA \#5}\end{matrix} ]}^{T} \qquad ( Expression 18 )$$

Direction estimator 213 may perform FFT processing using received vector h_{Azeropad} that is zero-padded until the FFT size becomes size N_{FFT}, which is a predetermined power of 2. In this case, spatial spectrum H_{A}(m) is expressed by following Expression 19. Here, m represents the FFT index. m=−N_{FFT}/2 to N_{FFT}/2+1. Here, h_{AZeroPad,n} represents the nth element of received vector h_{AZeropad}.

$$[ 21 ]$$

$${H}_{A} ( m ) = {\sum }_{n = 0}^{{N}_{FFT} - 1} {h}_{{A}_{ZeroPad} , n} {exp}^{- i \frac{2 π nm}{{N}_{FFT}}} \qquad ( Expression 19 )$$

$${h}_{{A}_{ZeroPad}} = {[ \begin{matrix}{h}_{A} & 0 & 0 & … & 0\end{matrix} ]}^{T}$$

Direction estimator 213 calculates phase change FFTpeakPhase (m_{PeakA}) at FFT index m_{peakA}, which is the peak on spatial spectrum H_{A}(m). Here, phase change FFTpeakPhase (m_{PeakA}) at FFT index m_{peakA}, which is the peak on spatial spectrum H_{A}(m), represents the phase change for each spatial sampling spacing D_{d} and depends on the azimuth and elevation angles at which the target object reflection wave arrives. For example, when the FFT processing expressed by above Expression 19 is performed, FFTpeakPhase (m_{PeakA}) is expressed as in following Expression 20:

$$[ 22 ]$$

$$FFTpeakPhase ( {m}_{PeakA} ) = \frac{2 π \times {m}_{PeakA}}{{N}_{FFT}} . \qquad ( Expression 20 )$$

Thus, direction estimator 213 calculates the phase change for each spacing D_{d} using the received signals of the virtual reception antennas that satisfy Arrangement Condition A (e.g., virtual reception antennas arranged in oblique direction ψ) among a plurality of virtual reception antennas.

(2) Direction estimator 213 calculates horizontal phase difference diffPhase_{H}(θ) using the received signals of at least two virtual reception antennas arranged in the horizontal direction that satisfy Arrangement Condition B. For example, in the virtual reception antennas in part (b) in FIG. 7, the virtual reception antennas arranged in the horizontal direction that satisfy Arrangement Condition B are VA #5 and VA #6, and horizontal phase difference diffPhase_{H}(θ₀) is calculated as in following Expression 21. Here, arg [x] is an operator representing the argument of complex number x. Additionally, superscript “* (asterisk)” is an operator representing the complex conjugate.

$$[ 23 ]$$

$${diffPhase}_{H} ( {θ}_{0} ) = \frac{2 π}{λ} {D}_{H} cos ϕ sin {θ}_{0} = arg [ {h}_{VA \#6} \times {h}_{VA \#5}^{*} ] \qquad ( Expression 21 )$$

Additionally, a candidate for the horizontal phase difference may include integer N_{ambiguityH} that satisfies the phase difference conditions shown in above Expression 21 and following Expression 22. For example, when N_{ambiguityH}=0 in Expression 22, Expression 22 corresponds to Expression 21. With this expression, candidates for the horizontal phase difference, including the true value direction and the grating lobe direction, are calculated.

$$[ 24 ]$$

$${diffPhase}_{H} ( {θ}_{{N}_{ambiguityH}} ) - {diffPhase}_{H} ( {θ}_{0} ) = 2 π {N}_{ambiguityH} \qquad ( Expression 22 )$$

$$where$$

$${N}_{ambiguityH} is an integer satisfying \vert sin {θ}_{0} + \frac{λ {N}_{ambiguityH}}{{D}_{H} cos ϕ} \vert \leq 1.$$

Note that, in part (b) in FIG. 7, in addition to VA #5 and VA #6, VA #2 and VA #3 are also a combination of virtual reception antennas arranged in the horizontal direction that satisfy Arrangement Condition B. Direction estimator 213 may calculate horizontal phase difference diffPhase_{H} using the received signals of VA #2 and VA #3, or may use the average of a plurality of phase differences diffPhase_{H}.

(3) Direction estimator 213 calculates vertical phase difference diffPhase_{V}(φ) using the received signals of at least two virtual reception antennas arranged in the vertical direction that satisfy Arrangement Condition C. For example, in the virtual reception antennas in part (b) in FIG. 7, the virtual reception antennas arranged in the vertical direction that satisfy Arrangement Condition C are VA #1 and VA #3, and vertical phase difference diffPhase_{V}(φ₀) is calculated as in following Expression 23:

$$[ 25 ]$$

$${diffPhase}_{V} ( {ϕ}_{0} ) = \frac{2 π}{λ} {D}_{V} sin {ϕ}_{0} = arg [ {h}_{VA \#3} \times {h}_{VA \#1}^{*} ] . \qquad ( Expression 23 )$$

Additionally, a candidate for the vertical phase difference may include integer N_{ambiguityV} that satisfies the phase difference conditions shown in above Expression 23 and following Expression 24. For example, when N_{ambiguityV}=0 in Expression 24, the expression corresponds to Expression 23. With this expression, the vertical phase difference candidates, including the true value direction and the grating lobe direction, are calculated.

$$[ 26 ]$$

$${diffPhase}_{V} ( {ϕ}_{{N}_{ambiguityV}} ) - {diffPhase}_{V} ( {ϕ}_{0} ) = 2 π {N}_{ambiguityV} \qquad ( Expression 24 )$$

$$where$$

$${N}_{ambiguityV} is an integer satisfying \vert sin {ϕ}_{0} + \frac{λ {N}_{ambiguityV}}{{D}_{V}} \vert \leq 1.$$

In addition to VA #1 and VA #3, VA #4 and VA #6 are combinations of virtual reception antennas arranged vertically that satisfy Arrangement Condition C in part (b) in FIG. 7. Direction estimator 213 may calculate vertical phase difference diffPhase_{V}(P) using the reception signals of VA #4 and VA #6, or it may use the average of a plurality of phase differences diffPhase_{V}.

When there are no vertically arranged virtual reception antennas satisfying Arrangement Condition C, radar apparatus 10 may use virtual reception antennas arranged in oblique direction ψ, excluding those satisfying Arrangement Condition A, to apply interpolation processing and obtain the reception signals of vertically arranged virtual reception antennas satisfying Arrangement Condition C.

For example, part (b) in FIG. 11 is an example of an arrangement where there are no vertically arranged virtual reception antennas satisfying Arrangement Condition C. In this case, for example, direction estimator 213 may obtain a reception signal of a vertically arranged virtual reception antenna satisfying Arrangement Condition C for VA #1 (position of point P in part (b) in FIG. 11; hereinafter referred to as “VA #P”) through interpolation processing.

For example, when at least two virtual reception antennas are not arranged in either the vertical or horizontal direction (vertical direction in FIG. 11), direction estimator 213 may calculate the phase difference in the one direction (vertical direction in FIG. 11) using interpolation processing with the reception signal of one of the virtual reception antennas in the second virtual reception antenna group (VA #3 and VA #6 in part (b) in FIG. 11).

For example, in part (b) in FIG. 11, VA #3 and point P are positioned in oblique direction, and VA #3 and point P are arranged with spacing D_{d}. Therefore, as shown in following Expression 25, reception signals h_{VA #P} of VA #P can be calculated by interpolation processing performed on reception signal h_{VA #3} of VA #3 using phase change FFTpeakPhase (m_{PeakA}) for each spatial sampling spacing D_{d} of the target object incoming wave calculated based on the virtual reception antennas satisfying Arrangement Condition A.

$$[ 27 ]$$

$${h}_{VA \# P} = {h}_{VA \# 3} {exp}^{- iFFTpeakPhase ( {m}_{PeakA} )} \qquad ( Expression 25 )$$

Alternatively, for example, in part (b) in FIG. 11, VA #6 and point P are positioned in oblique direction ψ, and VA #6 and point P are arranged with a spacing of 5 D_{d}. Therefore, as shown in following Expression 26, reception signal h_{VA #P} of VA #P can be calculated by interpolation processing on reception signal h_{VA #6} of VA #6 using FFTpeakPhase (m_{PeakA}).

$$[ 28 ]$$

$${h}_{VA \# P} = {h}_{VA \# 6} {exp}^{- iFFTpeakPhase ( {m}_{PeakA} ) \times 5} \qquad ( Expression 26 )$$

Alternatively, direction estimator 213 may, for example, further add and output the interpolated signals for the reception signals of a plurality of virtual reception antennas positioned in oblique direction ψ (e.g., VA #3 and VA #6 in part (b) in FIG. 11) as shown in following Expression 27. In this case, the signal-to-noise power ratio (SNR) of the reception signals is improved by the summation averaging process, enhancing the interpolation accuracy.

$$[ 29 ]$$

$${h}_{VA \# P} = ( {h}_{VA \# 3} {exp}^{- iFFTpeakPhase ( {m}_{PeakA} )} + {h}_{VA \# 6} {exp}^{- iFFTpeakPhase ( {m}_{PeakA} ) \times 5} ) / 2 \qquad ( Expression 27 )$$

Although the case where there are no vertically arranged virtual reception antennas satisfying Arrangement Condition C has been described, the reception signals of horizontally arranged virtual reception antennas satisfying Arrangement Condition B may also be calculated by applying interpolation processing using virtual reception antennas arranged in oblique direction ψ, excluding those satisfying Arrangement Condition A, when there are no horizontally arranged virtual reception antennas satisfying Arrangement Condition B. Furthermore, for the arrangement examples and variations described later, when there are no virtual reception antennas satisfying Arrangement Condition B or C, similar interpolation processing can be applied.

(4) Direction estimator 213 extracts the angles of arrival in the horizontal and vertical directions based on a combination which corresponds to (e.g., matches) phase change FFTpeakPhase (m_{PeakA}) for each spatial sampling spacing D_{d} of the target object incoming wave calculated based on virtual reception antennas satisfying Arrangement Condition A, from among combinations of horizontal phase difference diffPhase_{H}(θ_{NambiguityH}) calculated based on virtual reception antennas satisfying Arrangement Condition B and vertical phase difference diffPhase_{V}(φ_{NambiguityV}) calculated based on virtual reception antennas satisfying Arrangement Condition C.

For example, the phase change for each spatial sampling spacing D_{d} of horizontal phase difference diffPhase_{H}(θ_{NambiguityH}) calculated based on virtual reception antennas satisfying Arrangement Condition B and vertical phase difference diffPhase_{V}(φ_{NambiguityV}) calculated based on virtual reception antennas satisfying Arrangement Condition C is represented by HVPhase(θ_{N_ambiguityH}, φ_{N_ambiguityV}) as shown in following Expression 28. In direction estimator 213, a target object direction in the combination of horizontal phase difference diffPhase_{H}(θ_{NambiguityH}) and vertical phase difference diffPhase_{V}(φ_{NambiguityV}) with the smallest absolute value of the difference from FFTpeakPhase (m_{PeakA}) and HVPhase(θ_{N_ambiguityH}, φ_{N_ambiguityV}) may, for example, be the estimated target object direction.

$$[ 30 ]$$

$$HVPhase ( {θ}_{{N}_{ambiguityH}} , {ϕ}_{{N}_{ambiguityV}} ) = \frac{{D}_{d} cos ψ}{{D}_{H}} {diffPhase}_{H} ( {θ}_{{N}_{ambiguityH}} ) + \frac{{D}_{d} sin ψ}{{D}_{V}} {diffPhase}_{V} ( {ϕ}_{{N}_{ambiguityV}} ) \qquad ( Expression 28 )$$

The operation of the simplified two-dimensional angle measurement method in direction estimator 213 has been described.

Arrangement Example 1 and its variations have been described.

### Arrangement Example 2

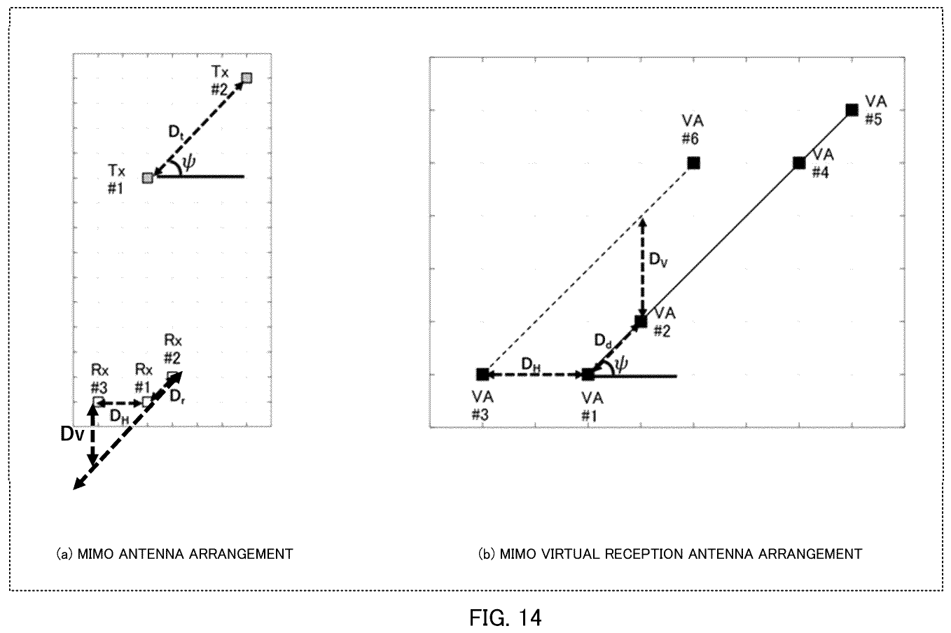

Part (a) in FIG. 14 illustrates an arrangement example of MIMO antennas of transmission antennas 106 and reception antennas 202 according to the above-described arrangement conditions. In the example shown in part (a) in FIG. 14, number N_{Tx} of transmission antennas is two (e.g., Tx #1 and Tx #2), and number Na of reception antennas is three (e.g., Rx #1, Rx #2, and Rx #3).

Part (b) in FIG. 14 illustrates an arrangement example of virtual reception antennas obtained by the antenna arrangement shown in part (a) in FIG. 14. The arrangement of virtual reception antennas is calculated by applying Expression 12 based on the antenna arrangement shown in part (a) in FIG. 14.

In part (a) in FIG. 14, N_{Tx} (=2) transmission antennas Tx #1 and #2 are arranged with spacing Dₜ in an oblique direction forming angle ψ (ψ=45° in part (a) in FIG. 14) with the horizontal direction. Note that oblique direction ψ is not limited to 45° and ψ may be set to, for example, about 30° to 60°.

In part (a) in FIG. 14, at least two reception antennas Rx #1 and #2 of the Na (=3) reception antennas are arranged with spacing Dᵣ in the same oblique direction ψ in which transmission antennas Tx #1 and #2.

Here, transmission antenna spacing Dₜ is set to four times the spacing of about 0.5λ, and reception antenna spacing Dᵣ may be set to a spacing of about 0.5λ. Therefore, transmission antenna spacing Dₜ and reception antenna spacing Dᵣ have absolute value D_{d} (=|Dₜ−Dᵣ|) of a difference between Dₜ and Dᵣ that is an integer multiple (3 times) of a spacing of about 0.5λ, and by setting reception antenna spacing Dᵣ=0.5λ, spacing D_{d} of about 0.5λ is included in the virtual reception antenna arrangement, satisfying Arrangement Condition A.

In part (a) in FIG. 14, reception antenna Rx #3 is arranged at a position with horizontal spacing D_{H} from reception antenna Rx #1. Note that reception antenna Rx #3 is arranged at a position with horizontal spacing D_{H} and vertical spacing D_{V} from oblique direction ψ. Here, by setting horizontal spacing D_{H}=λ/(2 sin ψ)≈0.7λ (when ψ is 45°), Arrangement Condition B is satisfied. In part (a) in FIG. 14, since reception antenna Rx #3 is not arranged to be aligned in a row with vertical spacing D_{V} from reception antenna Rx #1 or Rx #2, the virtual reception antenna arrangement shown in part (b) in FIG. 14 does not include an antenna arrangement arranged to be aligned in a row with vertical spacing D_{V}, and does not satisfy Arrangement Condition C.

Asis seen in part (a) in FIG. 14, transmission antennas Tx #1 and Tx #2 are arranged in oblique direction ψ. In part (a) in FIG. 14, two reception antennas Rx #1 and Rx #2 are arranged in oblique direction ψ with spacing Dᵣ (e.g., 0.5λ). In part (a) in FIG. 14, Rx #3 and Rx #1 are arranged with horizontal spacing D_{H} (wider than Dᵣ=0.5λ).

As shown in part (b) in FIG. 14, VA #1, VA #2, VA #4, and VA #5 are arranged in oblique direction ψ, and the spacing between two adjacent VA #1 and VA #2 is D_{d} (=0.5λ).

As shown in part (b) in FIG. 14, VA #1 and VA #3 (or VA #4 and VA #6) are arranged in the horizontal direction, and the spacing between VA #1 and VA #3 (or between VA #4 and VA #6) in the horizontal direction is D_{H} that is wider than D_{d}. From the above, the virtual reception antennas shown in part (b) in FIG. 14 satisfy Arrangement Conditions A and B.

Note that when number N_{Tx} of transmission antennas is three or more, at least two (e.g., Tx #1 and Tx #2) may satisfy the above arrangement conditions. Also, when number Na of reception antennas is three or more, at least three (e.g., Rx #1, Rx #2, and Rx #3) may satisfy the above arrangement conditions.

Next, an example of direction estimation processing performed by direction estimator 213 in the case where above-described Arrangement Example 2 is applied will be described.

For example, direction estimator 213 performs the direction estimation processing by generating virtual reception array correlation vectors h(f_{b_cfar}, f_{s_cfar}) of transmission antennas 106 given by Expression 13 using reception signals DeMul_{z}^{ncm}(f_{b_cfar}, f_{s_cfar}) that are the code multiplexed signals transmitted from transmission antennas 106 on which code demultiplexing processing is performed. The operations of direction estimator 213 are the same as those in the case of using Arrangement Example 1, and description thereof will be omitted.

### <Example of Direction Estimation Result of Arrangement Example 2>

Next, an example of a direction estimation result (computer simulation result) in the case where the antenna arrangement according to above-described Arrangement Example 2 is applied will be described.

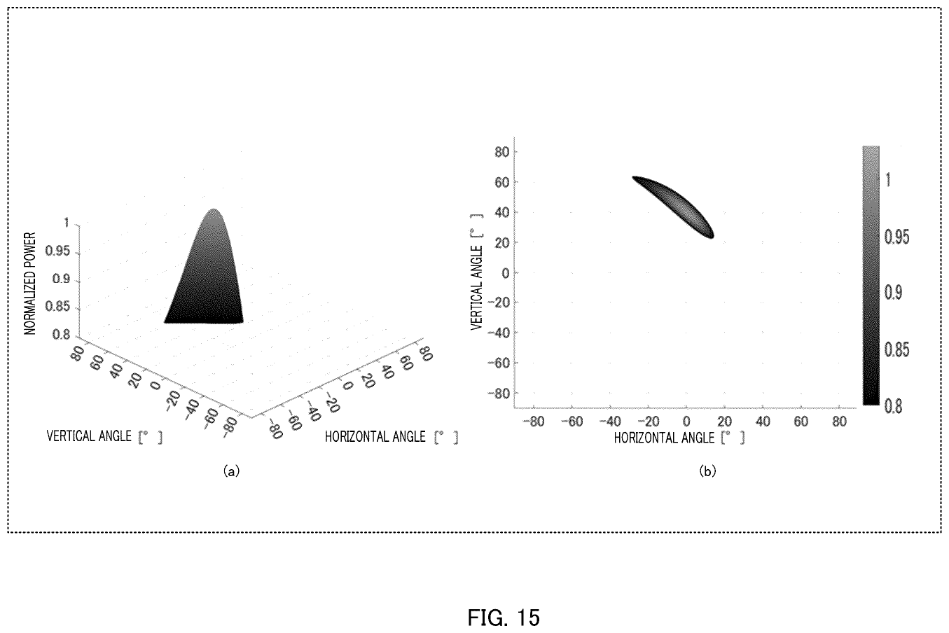

Parts (a) and (b) in FIG. 15 show the angle measurement results obtained by the beamforming method performed when receiving target object reflected waves from 0° in the horizontal direction and 40° in the vertical direction in the antenna arrangement of the MIMO radar shown in part (a) in FIG. 14. Parts (a) and (b) in FIG. 15 show the angle measurement results of Arrangement Example 1 (e.g., parts (a) and (b) in FIG. 8) under similar target object conditions, plotted using similar graphs.

From parts (a) and (b) in FIG. 15, it can be seen that the main beam is directed at horizontal 0° and vertical 40°, and no grating lobes are generated. Additionally, in the case of the MIMO radar antenna arrangement shown in part (a) in FIG. 14, the horizontal beam width is approximately 18°, and the vertical beam width is approximately 20° (in the Fourier beam pattern directed at horizontal 0° and vertical) 0°. Therefore, in the antenna arrangement of part (a) in FIG. 14, compared to the antenna arrangement of FIG. 1, the horizontal 3 dB beam width is reduced by 66% (=18/37), and the vertical 3 dB beam width is reduced by 34% (=20/59), leading to an expected improvement in two-dimensional angle measurement accuracy in the horizontal and vertical directions (e.g., an accuracy improvement effect of approximately 1.5 to 3 times).

Thus, in Arrangement Example 2, by satisfying Arrangement Conditions A and B, similar effects to those in Arrangement Example 1 can be obtained.

It should be noted that the antenna arrangement shown in part (a) in FIG. 14 is an example of the antenna arrangement that satisfies Arrangement Conditions A and B, but the present disclosure is not limited to this, and an antenna arrangement that satisfies Arrangement Condition A and at least one of Arrangement Conditions B and C may also be used.

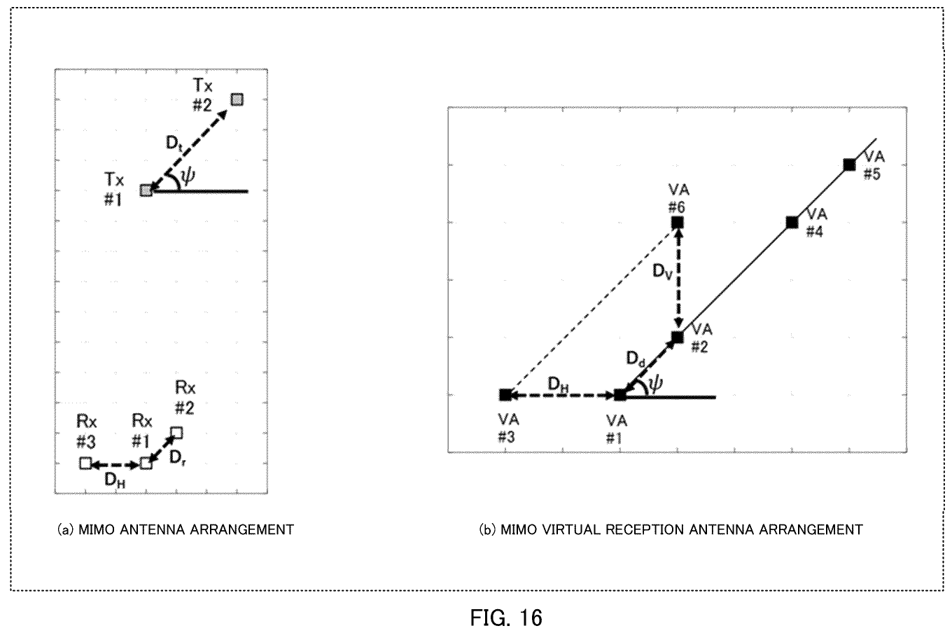

For example, the antenna arrangement shown in part (a) in FIG. 16 is a variation of Arrangement Example 2 that satisfies Arrangement Conditions A, B, and C. Part (b) in FIG. 16 is a diagram showing an example of the arrangement of virtual reception antennas obtained by the antenna arrangement shown in part (a) in FIG. 16. Even when using the antenna arrangement shown in part (a) in FIG. 16, similar effects to those in Arrangement Example 2 can be obtained, and grating lobes can be eliminated.

It should be noted that in the antenna arrangement shown in part (a) in FIG. 16, Rx #3 is not arranged in a line with vertical spacing D_{V} from Rx #1 or Rx #2, but as shown in the virtual reception antenna arrangement in part (b) in FIG. 16, virtual reception antennas VA #2 and VA #6 are arranged in a line with vertical spacing D_{V}. In this way, the positional relationship between the arrangement of transmission antennas 106 and the arrangement of reception antennas 202 allows for an arrangement that satisfies Arrangement Condition B or C.

The above describes Arrangement Example 2 and its variations.

### Arrangement Example 3

In Arrangement Examples 1 and 2 described above, the antenna configurations have been explained in which other reception antennas 202 are arranged in a line horizontally with respect to reception antennas 202 arranged obliquely to satisfy Arrangement Condition B. Additionally, in Arrangement Examples 1 and 2, the antenna configurations have been explained in which other reception antennas 202 are arranged in a line vertically with respect to reception antennas 202 arranged obliquely to satisfy Arrangement Condition C.

In relation to Arrangement Example 3, instead of the MIMO antenna arrangement related to the above-described arrangement examples, a method is described for obtaining, by using a MIMO antenna arrangement that satisfies the following arrangement conditions, similar effects to those obtained when Arrangement Condition B or C is satisfied. In the following, the arrangement conditions corresponding to Arrangement Conditions B and C are referred to as “Arrangement Condition B₁” and “Arrangement Condition C1,” respectively.

In Arrangement Example 3, Arrangement Condition A may be the same as in Arrangement Examples 1 and 2.

### [Arrangement Condition B₁]

At least one of the other reception antennas different from the reception antennas arranged in oblique direction ψ according to Arrangement Condition A is arranged on a straight line in oblique direction ψ that passes through point P that is horizontally spaced by horizontal spacing D_{H} from the reception antennas arranged in oblique direction ψ, and is arranged at a position shifted from point P by a spacing that is an integer multiple of D_{d}.

For example, among a plurality of reception antennas 202, a reception antenna (e.g., corresponding to the second reception antenna) different from at least two reception antennas arranged in oblique direction ψ (e.g., corresponding to the first reception antennas) is arranged in oblique direction ψ that passes through position P horizontally spaced by spacing D_{H} (wider than D_{d}) from at least one of the first reception antennas, and is arranged at a position spaced by an integer multiple of D_{d} away from position P.

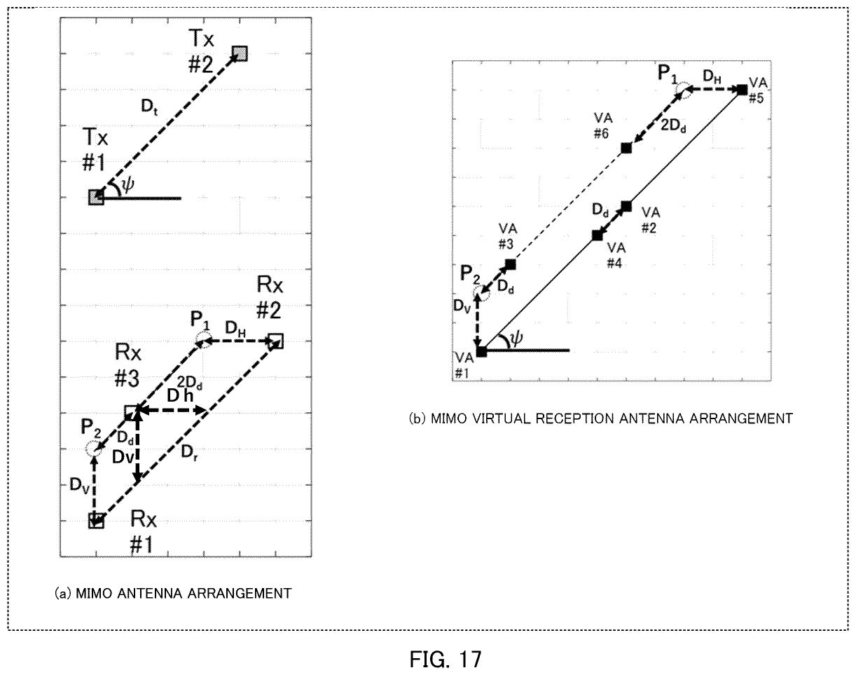

For example, at least one (e.g., Rx #3 in part (a) in FIG. 17) of the reception antennas excluding the reception antennas arranged in oblique direction ψ (e.g., Rx #1 and Rx #2 in part (a) in FIG. 17 described later) is arranged on a straight line in oblique direction ω that passes through point P (point P₁ in part (a) in FIG. 17) horizontally spaced by horizontal spacing D_{H} from the reception antennas arranged in oblique direction ψ (e.g., Rx #2 in part (a) in FIG. 17), and is arranged at a position shifted from point P by spacing Dₛ (Dₛ=2D_{d} in part (a) in FIG. 17). Here, horizontal spacing D_{H} may be set to λ/(2 sin ψ)≥D_{H}>λ/2.

Note that when D_{H}>λ/(2 sin ψ), grating lobes may occur in a specific azimuth/elevation range. When the radar detection area is a wide-angle range, there may be an influence by erroneous detection due to grating lobes, but when the radar detection area is a relatively narrow area near the front, there is no influence by grating lobes, and there is no impact on the deterioration of radar detection performance, so D_{H}>λ/(2 sin ψ) may be set.

### [Arrangement Condition C1]

At least one of the other reception antennas different from the reception antennas arranged obliquely in direction ψ according to Arrangement Condition A is arranged on a straight line in oblique direction ψ that passes through point P vertically spaced by vertical spacing D_{V} from the reception antennas arranged in oblique direction ψ, and is arranged at a position shifted from point P by a spacing that is an integer multiple of D_{d}.

For example, among a plurality of reception antennas 202, another reception antenna (e.g., corresponding to the second reception antenna) different from at least two reception antennas arranged in oblique direction ψ (e.g., corresponding to the first reception antennas) is arranged in oblique direction ψ that passes through position P, which is vertically spaced by spacing D_{H} (wider than D_{d}) from at least one of the first reception antennas, and is arranged at a position spaced by an integer multiple of D_{d} away from position P.

For example, at least one (e.g., Rx #3 in part (a) in FIG. 17) of the reception antennas excluding the reception antennas arranged in oblique direction ψ (e.g., Rx #1 and Rx #2 in part (a) in FIG. 17 described later) is arranged on a straight line in oblique direction ω that passes through point P (point P₂ in part (a) in FIG. 17) vertically spaced by vertical spacing D_{V} from the reception antennas arranged in oblique direction ψ (e.g., Rx #1 in part (a) in FIG. 17), and is arranged at a position shifted from point P by spacing Dₛ (Dₛ=D_{d} in part (a) in FIG. 17). Here, vertical spacing D_{V} may be set to λ/(2 cos ψ)≥D_{V}>λ/2. Note that reception antenna Rx #3 is arranged at a position with horizontal spacing D_{H} and vertical spacing D_{V} from oblique direction ψ.

Note that when D_{V}>λ/(2 cos ψ), grating lobes may occur in a specific azimuth/elevation range. When the radar detection area is a wide-angle range, there may be an influence by erroneous detection due to grating lobes, but when the radar detection area is a relatively narrow area near the front, there is no influence by grating lobes, and there is no impact on the deterioration of radar detection performance, so D_{H}>λ/(2 cos ψ) may be set.

The above describes Arrangement Conditions β₁ and C1.

With such antenna arrangements, virtual reception antennas (hereinafter referred to as “first oblique direction virtual reception antennas”) composed of reception antennas arranged obliquely in direction ψ according to Arrangement Condition A and transmission antennas arranged obliquely in direction ψ are arranged.

In addition to the first oblique direction virtual reception antennas, a virtual reception antenna (hereinafter referred to as “second oblique direction virtual reception antenna”) composed of another reception antenna excluding those arranged obliquely in direction ψ according to Arrangement Condition A and transmission antennas arranged obliquely in direction ψ is arranged in oblique direction ψ.

Here, the second oblique direction virtual reception antennas (e.g., VA #3 and VA #6 in part (b) in FIG. 17) are arranged while shifted by horizontal spacing D_{H} in the horizontal direction or by vertical spacing D_{V} in the vertical direction with respect to the first oblique direction virtual reception antennas (e.g., VA #1, #4, #2, and #5 in part (b) in FIG. 17 described later).

Thus, the virtual reception antennas composed of the transmission and reception antennas of radar apparatus 10 include, for example, virtual reception antennas (e.g., corresponding to the first virtual reception antenna group) that satisfy Arrangement Condition A, and are arranged in oblique direction ψ that passes through position P spaced by horizontal spacing D_{H} (e.g., wider than D_{d}) in the horizontal direction or by vertical spacing D_{V}(e.g., wider than D_{d}) in the vertical direction from at least one of the virtual reception antennas, and are arranged at positions spaced by an integer multiple of D_{d} away from position P (e.g., corresponding to the second antenna group).

Therefore, the phase of the received signal when reception antenna 202 is arranged on point P (point P₁ or point P₂ in part (b) in FIG. 17 described later) can be calculated by interpolation processing using the phase information on reception antenna 202 arranged at a position shifted by spacing Dₛ from point P and the phase change information on the received signal obtained in the first oblique direction virtual reception antennas. With such interpolation processing, Arrangement Example 3 can achieve similar effects to those obtained when reception antenna 202 is arranged at point P (e.g., Arrangement Example 1 or Arrangement Example 2), making it similarly applicable to the simplified two-dimensional angle measurement method. Therefore, when Arrangement Condition B₁ or C1 is satisfied, similar effects to those obtained when Arrangement Condition B or C is obtained can be obtained.

Note that spacing Dₛ is set to an integer multiple of spacing D_{d}. This allows for interpolation processing in the simplified two-dimensional angle measurement method described above. The application of the simplified two-dimensional angle measurement method results in a reduction in computational load in direction estimator 213.

Additionally, for example, spacing Dₛ may be set to a rational multiple of spacing D_{d}. This allows for interpolation processing in the simplified two-dimensional angle measurement method described above. The application of the simplified two-dimensional angle measurement method results in a reduction in computational load in direction estimator 213.

Part (a) in FIG. 17 illustrates an example of the arrangement of MIMO antennas of transmission antennas 106 and reception antennas 202 according to the above-described arrangement conditions. In the example shown in part (a) in FIG. 17, number N_{Tx} of transmission antennas is two (e.g., Tx #1 and Tx #2), and number Na of reception antennas is three (e.g., Rx #1, Rx #2, and Rx #3).

Part (b) in FIG. 17 illustrates an example of the arrangement of virtual reception antennas obtained by the antenna arrangement shown in part (a) in FIG. 17. The arrangement of virtual reception antennas is calculated by applying Expression 12 based on the antenna arrangement shown in part (a) in FIG. 17.

In part (a) in FIG. 17, N_{Tx} (=2) transmission antennas Tx #1 and Tx #2 are arranged with spacing Dₜ in an oblique direction forming angle ψ (ψ=45° in part (a) in FIG. 17) with the horizontal direction.

Additionally, in part (a) in FIG. 17, at least two reception antennas Rx #1 and Rx #2 of the Na (=3) reception antennas are arranged with spacing Dᵣ in the same oblique direction ψ in which transmission antennas Tx #1 and Tx #2.

Here, transmission antenna spacing Dₜ and reception antenna spacing Dᵣ may be set such that the absolute value D_{d} (=|Dₜ−Dᵣ|) of the difference between Dₜ and Dᵣ is approximately 0.5λ (1 times the defined value) (D_{d}≈0.5λ). In part (a) in FIG. 17, for example, spacing Dₜ is set to 2λ and spacing Dᵣ is set to 2.52. As a result, as shown in part (b) in FIG. 17, the virtual reception antenna arrangement includes spacing D_{d} of approximately 0.5λ, thus satisfying Arrangement Condition A.

Additionally, in part (a) in FIG. 17, reception antenna Rx #3 is arranged on a straight line in oblique direction ψ passing through point P₁ horizontally spaced by horizontal spacing D_{H} from reception antenna Rx #2 arranged in oblique direction ψ, and is arranged at a position shifted by spacing Dₛ₁=2D_{d} from point P₁. Here, horizontal spacing D_{H}=λ/(2 sin ψ)≈0.7λ (where ψ is) 45°, satisfying Arrangement Condition B1.

Additionally, in part (a) in FIG. 17, reception antenna Rx #3 is arranged on a straight line in oblique direction ψ, passing through point P₂ vertically spaced by vertical spacing D_{V} from reception antenna Rx #1 arranged in oblique direction, and is arranged at a position shifted by spacing Dₛ₂=D_{d} from point P₂. Here, vertical spacing D_{V}=λ/(2 cos ψ)≈0.7λ (where ψ is) 45°, satisfying Arrangement Condition C1.

Note that oblique direction ψ is not limited to 45° and ψ may be set to approximately 30° to 60°, for example.

Additionally, when number N_{Tx} of transmission antennas is three or more, at least two (e.g., Tx #1 and Tx #2) may satisfy the above arrangement conditions. Additionally, when number Na of reception antennas is three or more, at least three (e.g., Rx #1, Rx #2, and Rx #3) may satisfy the above arrangement conditions.

Next, an example of the direction estimation processing in direction estimator 213 performed when above-described Arrangement Example 3 is applied will be described.

For example, direction estimator 213 performs the direction estimation processing by generating virtual reception array correlation vectors h(f_{b_cfar}, f_{s_cfar}) of transmission antennas 106 given by Expression 13 using reception signals DeMul_{z}^{ncm}(f_{b_cfar}, f_{s_cfar}) that are the code multiplexed signals transmitted from transmission antennas 106 on which code demultiplexing processing is performed. The operations of direction estimator 213 are the same as those in the case of using Arrangement Example 1, and description thereof will be omitted.

### <Example of Direction Estimation Result of Arrangement Example 3>

Next, an example of a direction estimation result (computer simulation result) in the case where the antenna arrangement according to above-described Arrangement Example 3 is applied will be described.

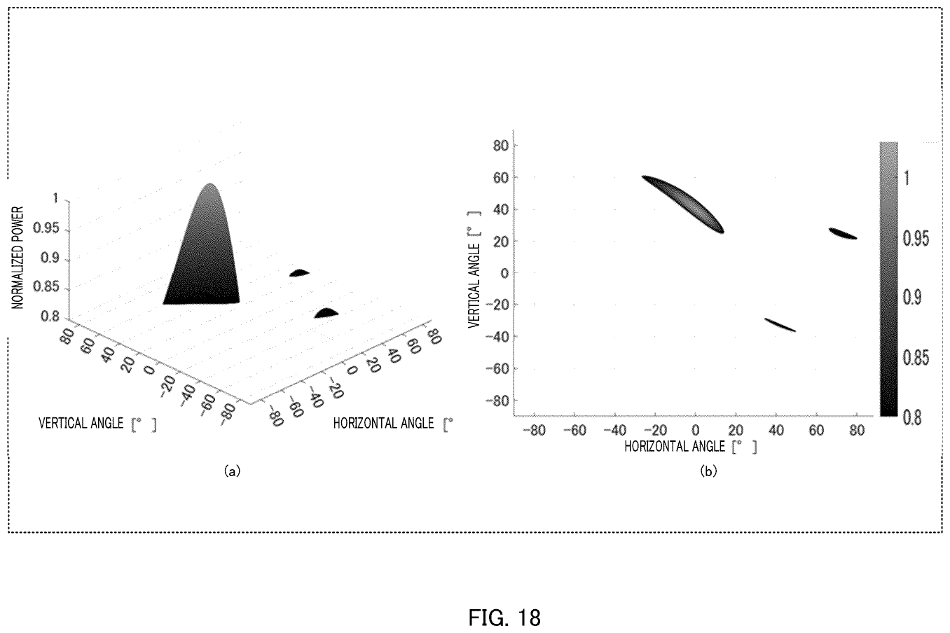

Parts (a) and (b) in FIG. 18 show the angle measurement results obtained by the beamforming method performed when receiving target object reflection waves from 0° in the horizontal direction and 40° in the vertical direction in the MIMO radar antenna arrangement shown in part (a) in FIG. 17. Parts (a) and (b) in FIG. 18 are plots under the same target object conditions as the angle measurement results of Arrangement Example 1 (e.g., parts (a) and (b) in FIG. 8), and are plots using similar graphs.

From parts (a) and (b) in FIG. 18, it can be seen that the main beam is directed at 0° in the horizontal direction and 40° in the vertical direction, and no grating lobes are generated. In the case of the MIMO radar antenna arrangement shown in part (a) in FIG. 17, the horizontal beam width is approximately 14°, and the vertical beam width is approximately 15° (in the case of a Fourier beam pattern directed at 0° in the horizontal direction and 0° in the vertical direction). Therefore, in the antenna arrangement of part (a) in FIG. 17, compared to the antenna arrangement of FIG. 1, the horizontal 3 dB beam width is reduced by 38% (=14/37), and the vertical 3 dB beam width is reduced by 25% (=15/59), resulting in an expected improvement in two-dimensional angle measurement accuracy in the horizontal and vertical directions (e.g., an accuracy improvement effect of approximately 2.6 to 3.9 times).

Thus, in Arrangement Example 3, by satisfying Arrangement Condition A and at least one of Arrangement Conditions β₁ and C1, the same effects as Arrangement Example 1 can be obtained.

Note that the antenna arrangement in Arrangement Example 3 is not limited to the antenna arrangement example shown in part (a) in FIG. 17.

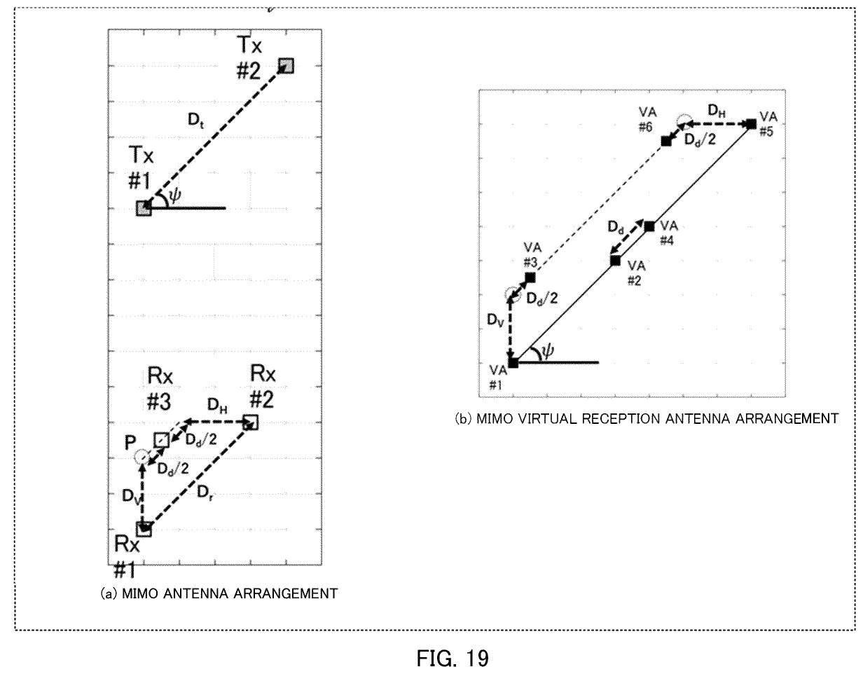

For example, the antenna arrangement shown in part (a) in FIG. 19 is a variation of Arrangement Example 3 that satisfies Arrangement Conditions A, B1, and C1. The antenna arrangement shown in part (a) in FIG. 19 is an arrangement with modifications in Dᵣ=3D_{d}, Dₛ₁=D_{d}/2, and Dₛ₂=D_{d}/2, compared to part (a) in FIG. 17. Part (b) in FIG. 19 illustrates an example of the arrangement of virtual reception antennas obtained by the antenna arrangement shown in part (a) in FIG. 19.

Even when using the antenna arrangement shown in part (a) in FIG. 19, the same effects as Arrangement Example 1 can be obtained. In the antenna arrangement shown in part (a) in FIG. 19, spacings Dₛ₁ and Dₛ₂ are set to D_{d}/2, which is a rational multiple (½ times) of D_{d}.

Additionally, the antenna arrangements of above-described Arrangement Example 3 (e.g., part (a) in FIG. 17) and its variation (e.g., part (a) in FIG. 19) are examples of antenna arrangements that satisfy Arrangement Conditions A, B1, and C1 with respect to Arrangement Example 1, but the present disclosure is not limited to this. For example, an antenna arrangement that satisfies Arrangement Conditions A, B1, and C1 with respect to Arrangement Example 2 (e.g., where reception antenna spacing Dᵣ is set to approximately 0.5λ) may also be used. In this case, the same effects as Arrangement Example 2 can be obtained.

Additionally, in Arrangement Example 3, spacing Dₜ of transmission antennas 106 may be an integer multiple or rational multiple of spacing D_{d}, spacing Dᵣ of reception antennas 202 may be an integer multiple or rational multiple of spacing D_{d}, and spacing Dₛ between point P on the straight line in oblique direction ψ and reception antennas 202 may be an integer multiple or rational multiple of spacing D_{d}.

The above describes Arrangement Example 3.

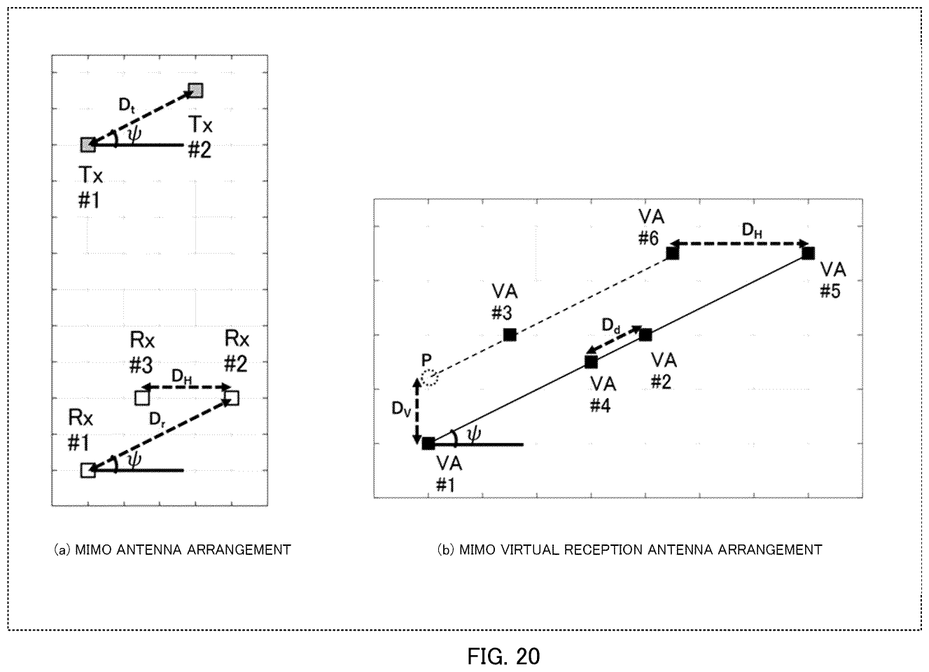

Note that in above-described Arrangement Examples 1, 2, and 3, the arrangement examples where oblique direction ψ=45° in Arrangement Condition A have been described, but the value of oblique direction ψ is not limited to this. For example, parts (a) and (b) in FIG. 20 show an example of a MIMO antenna arrangement and a virtual reception antenna arrangement when oblique direction ψ=30° in Arrangement Condition A. The antenna arrangement shown in part (a) in FIG. 20 satisfies Arrangement Conditions A and B, and provides the same effects as in the above-described arrangement examples.

For example, by setting oblique direction ψ=30°, the horizontal aperture length is expanded and becomes greater than the vertical aperture length, resulting in a greater improvement effect on horizontal direction estimation accuracy. For example, in the MIMO radar antenna arrangement shown in part (a) in FIG. 20, the horizontal beam width is approximately 16°, and the vertical beam width is approximately 51° (in the case of a Fourier beam pattern directed at 0° in the horizontal direction and 0° in the vertical direction) (not shown). Therefore, in the antenna arrangement of part (a) in FIG. 20, compared to the antenna arrangement of FIG. 1, the horizontal 3 dB beam width is reduced by 43% (=16/37), and the vertical 3 dB beam width is reduced by 86% (=51/59), resulting in a greater improvement effect on horizontal angle measurement accuracy (an accuracy improvement effect of approximately 2.3 times is expected) than the improvement effect on vertical angle measurement accuracy (an accuracy improvement effect of approximately 1.2 times is expected).

The embodiments of the present disclosure have been described above.

Note that, the configuration of the radar apparatus according to one exemplary embodiment of the present disclosure is not limited to the configuration illustrated in FIG. 5. For example, the radar apparatus does not have to include CFAR section 211.

Further, the parameters such as number N_{Tx} of transmission antennas, number Na of reception antennas, spacings of antennas (e.g., transmission antennas, reception antennas, or virtual reception antennas), and angle ψ in the diagonal direction in the antenna arrangements described in one exemplary embodiment of the present disclosure are examples, and may be other different values.

Additionally, in one exemplary embodiment of the present disclosure, an example using 0.5λ as one of the antenna spacings has been described, but the antenna interval is not limited to 0.5λ and may be other spacings of approximately 0.5λ. For example, spacings of approximately 0.5λ to 0.8λ may be applied.

In the radar apparatus according to the exemplary embodiment of the present disclosure, the radar transmitter and the radar receiver may be separately disposed at physically separate locations. In addition, in the radar receiver according to the exemplary embodiment of the present disclosure, the direction estimator and the other components may be separately arranged at physically separate locations.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Although various embodiments have been described above with reference to the drawings, it goes without saying that the present disclosure is not limited to foregoing embodiments. Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the present disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used for explaining the above-mentioned embodiments is realized as an LSI which is typically an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

In case that future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one exemplary embodiment of the present disclosure includes: transmission circuitry, which, in operation, transmits a transmission signal using either one of a first antenna group and a second antenna group; and reception circuitry, which, in operation, receives a reflected wave signal using an other of the first antenna group and the second antenna group, the reflected wave signal being the transmission signal reflected by an object, in which an r1th antenna and an r2th antenna of the first antenna group are arranged adjacent to each other in a third direction different from both a first direction and a second direction orthogonal to the first direction, a t1th antenna and a t2th antenna of the second antenna group are arranged adjacent to each other in the third direction, an r3th antenna of the first antenna group is arranged at a position shifted beyond a defined value in each of the first direction and the second direction from the third direction, the defined value being based on a wavelength of the transmission signal, and an absolute value of a difference between a spacing between the r1th antenna and the r2th antenna and a spacing between the t1th antenna and the t2th antenna is the defined value, or, the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

In the radar apparatus according to one exemplary embodiment of the present disclosure, when the first direction is a horizontal direction, the second direction is a vertical direction, and when the first direction is the vertical direction, the second direction is the horizontal direction.

In the radar apparatus according to one exemplary embodiment of the present disclosure, a number of antennas in the first antenna group is three or four, and a number of antennas in the second antenna group is two or three.

In the radar apparatus according to one exemplary embodiment of the present disclosure, the r1th antenna and the r3th antenna are arranged in the second direction, and a spacing of the r1th antenna and the r3th antenna is wider than the defined value in the second direction.

In the radar apparatus according to one exemplary embodiment of the present disclosure, the r1th antenna and the r3th antenna are arranged in a fourth direction different from the first direction, the second direction, and the third direction.

In the radar apparatus according to one exemplary embodiment of the present disclosure, a plurality of virtual reception antennas formed by the first antenna group and the second antenna group include: a first virtual reception antenna group arranged in the third direction, and a second virtual reception antenna group different from the first virtual reception antenna group and arranged in a fifth direction parallel to the third direction, at least one spacing between two adjacent virtual reception antennas included in the first virtual reception antenna group is the defined value based on the wavelength of the transmission signal, and a spacing in the first direction between one virtual antenna included in the first virtual reception antenna group and one virtual reception antenna included in the second virtual reception antenna group is wider than the defined value.

In the radar apparatus according to one exemplary embodiment of the present disclosure, a difference between an aperture length of the first virtual reception antenna group and an aperture length of the second virtual reception antenna group is equal to a predetermined multiple of the defined value.

In the radar apparatus according to one exemplary embodiment of the present disclosure, the defined value is 0.5 wavelengths.

In the radar apparatus according to one exemplary embodiment of the present disclosure, with respect to an angle ψ formed by the first direction and the third direction, the spacing between the r1th antenna and the r2th antenna is equal to or less than the wavelength/(2×sin ψ).

In the radar apparatus according to one exemplary embodiment of the present disclosure, with respect to an angle ψ formed by the first direction and the third direction, the spacing between the r1th antenna and the r3th antenna is equal to or less than the wavelength/(2×cos ψ).

In the radar apparatus according to one exemplary embodiment of the present disclosure, the reception circuitry calculates a phase change for each spacing of the defined value using a reception signal of a virtual reception antenna of the plurality of virtual reception antennas which is arranged in the third direction, calculates a phase difference in the first direction using reception signals of at least two virtual reception antennas of the plurality of virtual reception antennas, the at least two virtual reception antennas being arranged in the first direction, calculates a phase difference in the second direction using reception signals of at least two virtual reception antennas of the plurality of virtual reception antennas, the at least two virtual reception antennas being arranged in the second direction, and extracts an angle of arrival in the first direction and an angle of arrival in the second direction based on a combination from among combinations of the phase difference in the first direction and the phase difference in the second direction, the combination corresponding to the phase change for each spacing of the defined value.

In the radar apparatus according to one exemplary embodiment of the present disclosure, when the at least two virtual reception antennas are not arranged in either one of the first direction and the second direction, the reception circuitry calculates the phase difference in the one direction by interpolation processing using the reception signal of any one virtual reception antenna in the second virtual reception antenna group.

In the radar apparatus according to one exemplary embodiment of the present disclosure, the spacing between the r1th antenna and the r2th antenna is a predetermined multiple of the defined value that is no less than twice the defined value, and the spacing between the t1th antenna and the t2th antenna is a predetermined multiple of the defined value that is no less than twice the defined value.

In the radar apparatus according to one exemplary embodiment of the present disclosure, an angle formed by the first direction and the third direction is any angle within a range of 30° to 60°, inclusive.

A radar signal processing method according to one exemplary embodiment of the present disclosure includes: transmitting a transmission signal using either one of a first antenna group and a second antenna group; and receiving a reflected wave signal using an other of the first antenna group and the second antenna group, the reflected wave signal being the transmission signal reflected by an object, in which an r1th antenna and an r2th antenna of the first antenna group are arranged adjacent to each other in a third direction different from both a first direction and a second direction orthogonal to the first direction, a t1th antenna and a t2th antenna of the second antenna group are arranged adjacent to each other in the third direction, an r3th antenna of the first antenna group is arranged at a position shifted beyond a defined value in each of the first direction and the second direction from the third direction, the defined value being based on a wavelength of the transmission signal, and an absolute value of a difference between a spacing between the r1th antenna and the r2th antenna and a spacing between the t1th antenna and the t2th antenna is the defined value, or, the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

In the radar signal processing method according to one exemplary embodiment of the present disclosure, when the first direction is a horizontal direction, the second direction is a vertical direction, and when the first direction is the vertical direction, the second direction is the horizontal direction.

In the radar signal processing method according to one exemplary embodiment of the present disclosure, a number of antennas in the first antenna group is three or four, and a number of antennas in the second antenna group is two or three.

In the radar signal processing method according to one exemplary embodiment of the present disclosure, the r2th antenna and the r3th antenna are arranged in the second direction, and a spacing between the r2th antenna and the r3th antenna is wider than the defined value in the second direction.

In the radar signal processing method according to one exemplary embodiment of the present disclosure, the r1th antenna and the r3th antenna are arranged in a fourth direction different from the first direction, the second direction, and the third direction.

In the radar signal processing method according to one exemplary embodiment of the present disclosure, a plurality of virtual reception antennas formed by the first antenna group and the second antenna group include: a first virtual reception antenna group arranged in the third direction, and a second virtual reception antenna group different from the first virtual reception antenna group and arranged in a fifth direction parallel to the third direction, at least one spacing between two adjacent virtual reception antennas included in the first virtual reception antenna group is the defined value based on the wavelength of the transmission signal, and a spacing in the first direction between one virtual antenna included in the first virtual reception antenna group and one virtual reception antenna included in the second virtual reception antenna group is wider than the defined value.

While various embodiments have been described herein above, it is to be appreciated that various changes in form and detail may be made without departing from the sprit and scope of the disclosure(s) presently or hereafter claimed.

This application is entitled and claims the benefit of Japanese Patent Application No. 2024-091507, filed on Jun. 5, 2024, the disclosure of which including the specification, drawings and abstract is incorporated herein by reference in its entirety.

### INDUSTRIAL APPLICABILITY

The present disclosure is suitable as a radar apparatus for detection in a wide-angle range.

### REFERENCE SIGNS LIST

10 Radar apparatus
100 Radar transmitter
101 Radar transmission signal generator
102 Modulation signal generator
103 VCO
104 Code generator
105 Phase rotator
106 Transmission antenna
200 Radar receiver
201 Antenna system processor
202 Reception antenna
203 Reception radio
204 Mixer
205 LPF
206 Signal processor
207 AD converter
208 Beat frequency analyzer
209 Output switch
210 Doppler analyzer
211 CFAR section
212 Code demultiplexer
213 Direction estimator

1. A radar apparatus, comprising:
transmission circuitry, which, in operation, transmits a transmission signal using either one of a first antenna group and a second antenna group; and
reception circuitry, which, in operation, receives a reflected wave signal using an other of the first antenna group and the second antenna group, the reflected wave signal being the transmission signal reflected by an object, wherein
an r1th antenna and an r2th antenna of the first antenna group are arranged adjacent to each other in a third direction different from both a first direction and a second direction orthogonal to the first direction,
a t1th antenna and a t2th antenna of the second antenna group are arranged adjacent to each other in the third direction,
an r3th antenna of the first antenna group is arranged at a position shifted beyond a defined value in each of the first direction and the second direction from the third direction, the defined value being based on a wavelength of the transmission signal, and
an absolute value of a difference between a spacing between the r1th antenna and the r2th antenna and a spacing between the t1th antenna and the t2th antenna is the defined value, or,
the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

2. The radar apparatus according to claim 1, wherein:
when the first direction is a horizontal direction, the second direction is a vertical direction, and
when the first direction is the vertical direction, the second direction is the horizontal direction.

3. The radar apparatus according to claim 1, wherein
a number of antennas in the first antenna group is three or four, and a number of antennas in the second antenna group is two or three.

4. The radar apparatus according to claim 1, wherein:
the r1th antenna and the r3th antenna are arranged in the second direction, and
a spacing between the r1th antenna and the r3th antenna is wider than the defined value in the second direction.

5. The radar apparatus according to claim 1, wherein
the r1th antenna and the r3th antenna are arranged in a fourth direction different from the first direction, the second direction, and the third direction.

6. The radar apparatus according to claim 1, wherein:
a plurality of virtual reception antennas formed by the first antenna group and the second antenna group include:
a first virtual reception antenna group arranged in the third direction, and
a second virtual reception antenna group different from the first virtual reception antenna group and arranged in a fifth direction parallel to the third direction,
at least one spacing between two adjacent virtual reception antennas included in the first virtual reception antenna group is the defined value based on the wavelength of the transmission signal, and
a spacing in the first direction between one virtual antenna included in the first virtual reception antenna group and one virtual reception antenna included in the second virtual reception antenna group is wider than the defined value.

7. The radar apparatus according to claim 6, wherein
a difference between an aperture length of the first virtual reception antenna group and an aperture length of the second virtual reception antenna group is equal to a predetermined multiple of the defined value.

8. The radar apparatus according to claim 1, wherein
the defined value is 0.5 wavelengths.

9. The radar apparatus according to claim 1, wherein
with respect to an angle ψ formed by the first direction and the third direction, the spacing between the r1th antenna and the r2th antenna is equal to or less than the wavelength/(2×sin ψ).

10. The radar apparatus according to claim 4, wherein
with respect to an angle ψ formed by the first direction and the third direction, the spacing between the r1th antenna and the r3th antenna is equal to or less than the wavelength/(2×cos ψ).

11. The radar apparatus according to claim 6, wherein:
the reception circuitry
calculates a phase change for each spacing of the defined value using a reception signal of a virtual reception antenna of the plurality of virtual reception antennas which is arranged in the third direction,
calculates a phase difference in the first direction using reception signals of at least two virtual reception antennas of the plurality of virtual reception antennas, the at least two virtual reception antennas being arranged in the first direction,
calculates a phase difference in the second direction using reception signals of at least two virtual reception antennas of the plurality of virtual reception antennas, the at least two virtual reception antennas being arranged in the second direction, and
extracts an angle of arrival in the first direction and an angle of arrival in the second direction based on a combination from among combinations of the phase difference in the first direction and the phase difference in the second direction, the combination corresponding to the phase change for each spacing of the defined value.

12. The radar apparatus according to claim 11, wherein
when the at least two virtual reception antennas are not arranged in either one of the first direction and the second direction, the reception circuitry calculates the phase difference in the one direction by interpolation processing using the reception signal of any one virtual reception antenna in the second virtual reception antenna group.

13. The radar apparatus according to claim 1, wherein:
the spacing between the r1th antenna and the r2th antenna is a predetermined multiple of the defined value that is no less than twice the defined value, and
the spacing between the t1th antenna and the t2th antenna is a predetermined multiple of the defined value that is no less than twice the defined value.

14. The radar apparatus according to claim 1, wherein
an angle formed by the first direction and the third direction is any angle within a range of 30° to 60°, inclusive.

15. A radar signal processing method, comprising:
transmitting a transmission signal using either one of a first antenna group and a second antenna group; and
receiving a reflected wave signal using an other of the first antenna group and the second antenna group, the reflected wave signal being the transmission signal reflected by an object, wherein
an r1th antenna and an r2th antenna of the first antenna group are arranged adjacent to each other in a third direction different from both a first direction and a second direction orthogonal to the first direction,
a t1th antenna and a t2th antenna of the second antenna group are arranged adjacent to each other in the third direction,
an r3th antenna of the first antenna group is arranged at a position shifted beyond a defined value in each of the first direction and the second direction from the third direction, the defined value being based on a wavelength of the transmission signal, and
an absolute value of a difference between a spacing between the r1th antenna and the r2th antenna and a spacing between the t1th antenna and the t2th antenna is the defined value, or,
the absolute value of the difference between the spacing between the r1th antenna and the r2th antenna and the spacing between the t1th antenna and the t2th antenna is an integer multiple of the defined value that is no less than twice the defined value, and either one of the spacing between the r1th antenna and the r2th antenna and the spacing between the t1th antenna and the t2th antenna is the defined value.

16. The radar signal processing method according to claim 15, wherein:
when the first direction is a horizontal direction, the second direction is a vertical direction, and
when the first direction is the vertical direction, the second direction is the horizontal direction.

17. The radar signal processing method according to claim 15, wherein
a number of antennas in the first antenna group is three or four, and a number of antennas in the second antenna group is two or three.

18. The radar signal processing method according to claim 15, wherein:
the r2th antenna and the r3th antenna are arranged in the second direction, and
a spacing between the r2th antenna and the r3th antenna is wider than the defined value in the second direction.

19. The radar signal processing method according to claim 15, wherein
the r1th antenna and the r3th antenna are arranged in a fourth direction different from the first direction, the second direction, and the third direction.

20. The radar signal processing method according to claim 15, wherein:
a plurality of virtual reception antennas formed by the first antenna group and the second antenna group include:
a first virtual reception antenna group arranged in the third direction, and
a second virtual reception antenna group different from the first virtual reception antenna group and arranged in a fifth direction parallel to the third direction,
at least one spacing between two adjacent virtual reception antennas included in the first virtual reception antenna group is the defined value based on the wavelength of the transmission signal, and
a spacing in the first direction between one virtual antenna included in the first virtual reception antenna group and one virtual reception antenna included in the second virtual reception antenna group is wider than the defined value.
